(19) United States
(12) Patent Application Publication
(10) Pub. No.: US 2021/0309913 A1
(43) Pub. Date: Oct. 7, 2021

(54) COMPOSITION FOR CORRECTING COLOR BLINDNESS

(71) Applicant: NITTO DENKO CORPORATION, Osaka (JP)

(72) Inventor: Brett T. Harding, Oceanside, CA (US)

(21) Appl. No.: 17/269,920

(22) PCT Filed: Aug. 27, 2019
(86) PCT No.: PCT/US2019/048358

§ 371 Date: Feb. 19, 2021

Related U.S. Application Data
(60) Provisional application No. 62/723,403, filed on Aug. 27, 2018.

(51) Int. Cl. C09K 11/06; C09B 11/24; C09B 47/00; G02C 7/10

(52) U.S. Cl. CPC C09K 11/06; C09B 11/24; C09K 2211/1018; G02C 7/108; C09B 47/00

(57) ABSTRACT

Described herein are compositions, optical elements, and methods for improving color discernment. Disclosed is a composition comprising: a luminescent compound; and a light absorbing dye. The luminescent compound is preferably rhodamine B: (I). The light absorbing dye is preferably the porphyrin derivative below: (II).

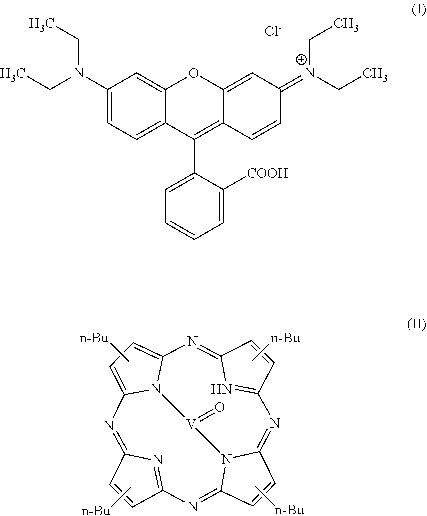

### CROSS-REFERENCE TO RELATED APPLICATIONS

This application claims the benefit of U.S. Provisional Application No. 62/723,403, filed Aug. 27, 2018, which is incorporated by reference in its entirety.

### FIELD

The present disclosure relates to compositions and elements for the correction of color blindness. Methods for the preparation of the compositions and elements are also disclosed herein.

### BACKGROUND

Color blindness is the decreased ability to see colors or to discern color differences. Currently, there exists no cure for this condition. Several types of color blindness exist. Red-green color blindness is the most common form, and can be further classified as protanopia, deuteranopia, protanomaly and deuteranomaly, with the latter two conditions being the most common. A protanomalous individual is less sensitive to red light than normal individuals and thus suffers from a darkening effect of the red end of the spectrum. A deuteranomalous individual possesses a mutated form of the green pigment, which is shifted towards the red end of the spectrum resulting in a reduction in sensitivity to the green area of the spectrum. Like the protanomates, deuteranomates are poor at discriminating small differences in hues in the red, orange, yellow, green region of the spectrum. This red-green color blindness condition causes many of these hues to appear shifted towards the red end of the color spectrum. Other individuals have blue-yellow color blindness, classified as tritanopia and tritanomaly. Tritanomous persons possess a mutated form of the blue pigment, which causes a shift towards the green area of the spectrum.

Several methods have been proposed for the correction of color blindness in human beings. Generally, options to correct for lack of visual color discrimination include using differential coloration, filtration, and spectral transmission between concurrently used lenses. Other methods include associating color with other visual indicators, e.g., cross hatching, as a manner for correcting visual color deficiencies.

### SUMMARY

Compositions described herein may be used to improve a person's ability to distinguish colors. These compositions may be of benefit to both individuals having normal color vision and individuals having an impaired ability to distinguish colors. The present embodiments relate to compositions and optical elements useful for enhancing color discrimination by persons having visual insensitivity between colors, e.g., correcting color blindness, that enhances transmission of one or more desired emissive bandwidths corresponding to a color that a person perceives as difficult to identify or distinguish. The bandwidth can be in the red, yellow, green, or blue region of visible wavelength light. In an embodiment, the composition can both enhance the transmission of a desired first emissive bandwidth and decrease the transmission of a second emissive bandwidth. For example, a person having color blindness may be able to perceive a first color but confuse a second color with the first color. In an embodiment, the composition and/or optical element can enhance the contrast or intensity between the two colors, increasing their distinction from one another.

Some embodiments include a composition comprising: a luminescent compound; and a light absorbing dye; wherein the luminescent compound has a median wavelength of visible absorption, an average wavelength of visible absorption, or a peak wavelength of visible absorption in a range about 530 nm to about 580 nm; wherein the addition of the light absorbing dye has full width at half max in a range of about 10 nm to about 40 nm, and addition of the light absorbing dye to the composition results in a second absorption peak at a wavelength above about 580 nm; wherein the composition has a transmittance of at least 10% at 450 nm and a transmittance of at least 10% at 650 nm.

Some embodiments include an optical element for correcting visual insensitivity between a first visible color wavelength and a second visible color wavelength, comprising: a substantially transparent matrix material; a luminescent compound; and a light absorbing dye; wherein the luminescent compound and the light absorbing dye are dispersed within the substantially transparent matrix material, wherein the luminescent compound has an emissive wavelength that substantially overlaps with the first visible color wavelength and the light absorbing dye has an absorbance wavelength that substantially overlaps with the first visible color wavelength and absorbs about 1% to about 99.9% of the first visible light color wavelength that would otherwise pass through the optical element.

An embodiment comprises a composition for improving color discernment, such as correcting visual insensitivity between a first visible color wavelength and a second visible color wavelength. In an embodiment, the composition comprises a luminescent compound and a light absorbing dye. In some embodiments, the luminescent compound can absorb light in a wavelength range near peak sensitivity for an M human cone photopigment and emits light of a longer wavelength in a wavelength range near peak sensitivity for a L human cone photopigment. In some embodiments, the luminescent compound can have a median wavelength of visible absorption, an average wavelength of visible absorption, or a peak wavelength of visible absorption of about 530 nm to about 650 nm. In some embodiments, the light absorbing dye can have a full width half maximum of visible absorption of up to and including 100 nm. In some embodiments, the light absorbing dye can have a full width half maximum of visible absorption in a range of about 10-40 nm, about 10-30 nm, or about 20 nm. Some embodiments include a luminescent compound that has a fluorescent emission that substantially overlaps a human L cone emission wavelength range. In some embodiments, the luminescent compound can comprise a rhodamine or a rhodamine derivative. In some embodiments, the luminescent compound can comprise rhodamine B.

Some embodiments include a light absorbing dye, wherein the light absorbing dye can have an absorption wavelength range that overlaps with the luminescent compound's emission wavelength range. In some embodiments, the light absorbing dye can have an absorbance maximum of about 585 nm to about 605 nm. In some embodiments, the light absorbing dye can reduce the fluorescent emission of the luminescent compound by about 50% to about 99.9%. In some embodiments, the light absorbing dye can have a fluorescent yield of less than 1%. In some embodiments, the light absorbing dye can comprise a porphyrin or porphyrin derivative.

In some embodiments, the optical element can further comprise a substantially transparent matrix. In some embodiments, the substantially transparent matrix can comprise any material suitable for an optical lens or contact lens.

Some embodiments include an optical element for correcting visual insensitivity between a first visible color wavelength and a second visible color wavelength. In some embodiments, the optical element can comprise a substantially transparent matrix. In some embodiments, the optical element can comprise a luminescent compound. In some embodiments, the optical element can comprise a light absorbing dye. In some embodiments, the luminescent compound and the light absorbing dye can be dispersed within the substantially transparent matrix material. In some embodiments, the luminescent compound can have an emission wavelength that substantially overlaps with the first visible color wavelength. In some embodiments, the light absorbing dye can absorb about 1% to about 99.9% of the first visible color wavelength that would otherwise pass through the optical element. In some embodiments, the luminescent compound can comprise a rhodamine or a rhodamine derivative dye. In some embodiments, the rhodamine derivative can be rhodamine B. In some embodiments, the light absorbing dye can comprise a porphyrin or a porphyrin derivative.

Generally, the compositions described herein may be used to improve ability to distinguish colors by an individual having an impaired ability to distinguish colors and/or by an individual with normal color vision.

These and other embodiments are described in greater detail below.

### BRIEF DESCRIPTION OF THE DRAWINGS

FIG. 1 shows the light transmittance for experimental examples described herein.

FIG. 2 shows the % haze produced for experimental examples described herein.

### DETAILED DESCRIPTION

The current disclosure describes compositions that may be used to improve a person's ability to distinguish colors. These compositions may be of benefit to both individuals having normal color vision and individuals having an impaired ability to distinguish colors. The present embodiments relate to compositions and optical elements useful for enhancing color discrimination by persons having visual insensitivity between colors, e.g., correcting color blindness. Some embodiments include enhanced transmission of one or more desired emissive bandwidths corresponding to a color that a person perceives as difficult to identify or distinguish. The bandwidth can be in the red, yellow, green, or blue region of visible wavelength light. In an embodiment, the composition can both enhance the transmission of a desired first emissive bandwidth and decrease the transmission of a second emissive bandwidth. For example, a person having color blindness may be able to perceive a first color but confuse a second color with the first color. In an embodiment, the composition can enhance the contrast or intensity between the two colors, increasing their distinction from one another.

Generally, to help an individual distinguish colors, it may be helpful for the composition to have a degree of transparency, such as a transmittance of at least 10%, at least 20%, at least 30%, at least 40%, at least 50%, at least 60%, at least 70%, at least 80%, or at least 90%, at a variety of visible wavelengths, such as wavelengths of about 400-700 nm, e.g. at 450 nm and/or at 650 nm.

A composition comprising a luminescent compound and a light absorbing dye is described herein. In some embodiments, the composition can comprise a luminescent compound. In some embodiments, the luminescent compound can absorb light in a wavelength range near peak sensitivity for a normal human cone middle-wavelength sensitive (M) photopigment, or alternatively, in a range where the M photopigment has sensitivity. In some embodiments, the luminescent compound can emit light of a longer wavelength in a wavelength range near peak sensitivity for a normal human cone long-wavelength sensitive (L) photopigment, or alternatively, in a range where the L photopigment has sensitivity. In some embodiments, the luminescent compound can have a median wavelength of visible absorption, an average wavelength of visible absorption, or a peak wavelength of visible absorption of about 530 nm to about 600 nm. In some embodiments, the light absorbing dye can have a full width half maximum of about 10-40 nm, about 10-30 nm, or about 20 nm.

In some embodiments, the luminescent compound may absorb light at an absorption wavelength and emit light at an emission wavelength, wherein a human cone photopigment is substantially more sensitive to the emission wavelength than to the absorption wavelength. For example, the human cone photopigment may be at least about 1.5, about 2, about 3, or about 4 times; and/or up to about 10 times, about 20 times, about 50 times, or about 100 times as sensitive to the emission wavelength as it is to the absorption wavelength. In some embodiments, a human cone photopigment is less sensitive to at least about 50%, at least about 70%, at least about 80%, or at least about 90%; and/or up to about 100%; of the visible light absorbed by the luminescent compound as compared to the visible light emitted by the luminescent compound.

Enhanced sensitivity may be with respect to any photopigment, such as a normal human cone middle-wavelength sensitive (M) photopigment, a variant human cone middle-wavelength sensitive (MV) photopigment, a normal human cone long-wavelength sensitive (L) photopigment, variant human cone long-wavelength sensitive (LV) photopigment, or a normal human cone short-wavelength sensitive (S) photopigment, provided that the absorption and emission sensitivities are compared with respect to the same photopigment.

In some embodiments, a luminescent compound has a median wavelength of visible absorption, an average wavelength of visible absorption, a peak wavelength of visible absorption, a maximum wavelength of visible absorption, of at least about 20%, about 50%, about 70%, or about 90% of its visible absorption, in a range of about 380 nm to about 450 nm, about 420 nm to about 480 nm, about 510 nm to about 550 nm, about 520 nm to about 540 nm, about 530 nm to about 550 nm, or about 540 nm to about 590 nm. In some embodiments, the luminescent compound can have fluorescent emission that substantially overlaps with a human L cone light absorption wavelength range. In some embodiments, a luminescent compound has a median wavelength of visible emission, an average wavelength of visible emission, a peak wavelength of visible emission, a maximum wavelength of visible emission, of at least about 20%, at least about 50%, at least about 70%, or at least about 90% of its visible emission in a range of about 500 nm to about 650 nm, about 540 nm to about 580 nm, about 550 nm to about 570 nm, or about 560 nm to about 580 nm.

A median wavelength of visible absorption of a luminescent compound is the wavelength at which the number of visible photons absorbed having a longer wavelength than the median wavelength is substantially the same as the number of visible photons absorbed having a shorter wavelength than the median wavelength. A median wavelength of visible emission of a compound is the wavelength at which the number of visible photons emitted having a longer wavelength than the median wavelength is substantially the same as the number of visible photons emitted having a shorter wavelength than the median wavelength. A median wavelength may be visually estimated on a spectrum by choosing a wavelength that divides the area of the visible spectrum into two substantially equal halves. An average wavelength of visible absorption (or visible emission) is the average wavelength of all photons in the visible range. A peak wavelength of visible absorption or visible emission is a peak in the light absorbance spectrum in the visible range. A maximum wavelength of visible absorption or visible emission is the highest peak wavelength in the visible spectrum. As used herein, the terms “absorption,” “absorb,” or a form of these terms, are used as shorthand for “a median wavelength of visible absorption, an average wavelength of visible absorption, a peak wavelength of visible absorption, a maximum wavelength of visible absorption, or a wavelength range in which at least about 50%, about 80%, or about 90% of visible light absorption occurs.” As used herein, the terms “emission,” “emit,” or a form of these terms are used as shorthand for “a median wavelength of visible emission, an average wavelength of visible emission, a peak wavelength of visible emission, a maximum wavelength of visible emission, or a wavelength range in which at least about 50%, about 80%, or about 90% of visible light emission occurs.”

In some embodiments, a luminescent compound may absorb light in a wavelength range near peak sensitivity for an M human cone photopigment, such as a wavelength range where relative sensitivity (Table 1) is at least about 0.9 (e.g. about 510 nm to about 550 nm), about 0.93, about 0.95, about 0.96, about 0.97, about 0.98, about 0.99, or about 1.0; and emit light of a longer wavelength in a wavelength range near peak sensitivity for an L human cone photopigment, such as a wavelength range where relative sensitivity (Table 1) is at least about 0.9 (e.g. about 540 nm to about 580 nm for M human cone photopigments), about 0.93, about 0.95, about 0.96, about 0.97, about 0.98, about 0.99, or about 1.0. An optical element may generally emit at a higher wavelength than it absorbs, such as at a wavelength that is at least about 5 nm, about 10 nm, about 20 nm, or about 30 nm higher. In some embodiments, an optical element may have an absorption that is slightly red-shifted with respect to peak sensitivity for an M human cone photopigment and may have an emission that is slightly blue-shifted with respect to peak sensitivity for an L human cone photopigment.

Relative sensitivities of an M, an L, an S, an MV, and an LV human photopigment are listed in Table 1. The relative sensitivities are scaled to a maximum sensitivity of 1.00 for each photopigment. Suitable absorption and emission ranges for a luminescent compound, or a combination of luminescent compounds may be derived from any set of values in Table 1. For example, a luminescent compound may absorb in a low sensitivity range for the M photopigment, such as about 384 nm to about 440 nm, about 380 nm to about 410 nm, or any other range defined by any values in Table 1 in these ranges; and may emit in a high sensitivity range for the M photopigment such as about 465 nm to about 585 nm, about 510 nm to about 550 nm, or any other range defined by any values in Table 1 in these ranges. In some embodiments, a luminescent compound may absorb in a low sensitivity range for the L photopigment, such as about 384 nm to about 460 nm, about 380 nm to about 430 nm, or any other range defined by any values in Table 1 in these ranges; and may emit in a high sensitivity range for the L photopigment such as about 495 nm to about 620 nm, about 540 nm to about 580 nm, or any other range defined by any values in Table 1 in these ranges.

Suitable ranges for absorption and emission of an optical element, a luminescent compound, or a combination of luminescent compound(s) and light absorbing dye(s) may also be derived from the sensitivity values from Table 1. For example, for a given photopigment, an absorption range may correspond to wavelengths with sensitivity values below about 0.15, about 0.2, about 0.25, or about 0.3, and an emission range may correspond to wavelengths with sensitivity values about above about 0.4, about 0.5, about 0.6, about 0.7, about 0.8, about 0.9, or about 1 from Table 1. Ranges derived from Table 1 may include median visible wavelength ranges, average visible wavelength ranges, peak visible wavelength ranges, maximum visible wavelength ranges, etc., or may include ranges within which at least about 50%, about 70%, about 80%, or about 90% of the photons in the visible spectrum are emitted or absorbed. In some embodiments, absorption may correspond to a sensitivity value of at least about 0.5, about 0.6, about 0.7, about 0.8, about 0.9, up to about 1 for an M photopigment.

TABLE 1
Relative Sensitivity of Various Photopigments in the Visible Range

| Wavelength (nm) | M | L | S | MV | LV |
|---|---|---|---|---|---|
| 384 | 0.125 | 0.123 | 0.709 | 0.125 | 0.123 |
| 385 | 0.125 | 0.123 | 0.724 | 0.125 | 0.123 |
| 386 | 0.125 | 0.123 | 0.739 | 0.125 | 0.123 |
| 387 | 0.125 | 0.123 | 0.768 | 0.125 | 0.123 |
| 388 | 0.125 | 0.123 | 0.788 | 0.125 | 0.123 |
| 389 | 0.125 | 0.123 | 0.798 | 0.125 | 0.123 |
| 390 | 0.125 | 0.123 | 0.808 | 0.125 | 0.123 |
| 391 | 0.125 | 0.123 | 0.818 | 0.125 | 0.123 |
| 392 | 0.125 | 0.123 | 0.828 | 0.125 | 0.123 |
| 393 | 0.126 | 0.123 | 0.847 | 0.125 | 0.123 |
| 394 | 0.126 | 0.123 | 0.867 | 0.125 | 0.123 |
| 395 | 0.126 | 0.123 | 0.887 | 0.125 | 0.123 |
| 396 | 0.126 | 0.123 | 0.897 | 0.125 | 0.123 |
| 397 | 0.126 | 0.123 | 0.906 | 0.125 | 0.123 |
| 398 | 0.126 | 0.123 | 0.926 | 0.125 | 0.123 |
| 399 | 0.127 | 0.123 | 0.936 | 0.125 | 0.123 |
| 400 | 0.127 | 0.123 | 0.946 | 0.125 | 0.123 |
| 401 | 0.127 | 0.123 | 0.956 | 0.126 | 0.123 |
| 402 | 0.127 | 0.123 | 0.966 | 0.126 | 0.123 |
| 403 | 0.127 | 0.123 | 0.978 | 0.126 | 0.123 |
| 404 | 0.127 | 0.123 | 0.983 | 0.126 | 0.123 |
| 405 | 0.127 | 0.123 | 0.987 | 0.126 | 0.123 |
| 406 | 0.127 | 0.123 | 0.990 | 0.126 | 0.123 |
| 407 | 0.127 | 0.123 | 0.993 | 0.127 | 0.123 |
| 408 | 0.127 | 0.123 | 0.995 | 0.127 | 0.123 |
| 409 | 0.127 | 0.123 | 0.997 | 0.127 | 0.123 |
| 410 | 0.127 | 0.123 | 0.999 | 0.127 | 0.123 |
| 411 | 0.127 | 0.123 | 1.000 | 0.127 | 0.123 |
| 412 | 0.127 | 0.123 | 1.000 | 0.127 | 0.123 |
| 413 | 0.128 | 0.123 | 1.000 | 0.127 | 0.123 |
| 414 | 0.127 | 0.123 | 0.999 | 0.127 | 0.123 |
| 415 | 0.129 | 0.123 | 0.998 | 0.127 | 0.123 |
| 416 | 0.131 | 0.123 | 0.997 | 0.127 | 0.123 |
| 417 | 0.133 | 0.123 | 0.990 | 0.127 | 0.123 |
| 418 | 0.135 | 0.123 | 0.988 | 0.127 | 0.123 |
| 419 | 0.137 | 0.123 | 0.985 | 0.127 | 0.123 |
| 420 | 0.139 | 0.123 | 0.977 | 0.127 | 0.123 |
| 421 | 0.141 | 0.123 | 0.966 | 0.128 | 0.123 |
| 422 | 0.143 | 0.123 | 0.961 | 0.127 | 0.123 |
| 423 | 0.145 | 0.123 | 0.956 | 0.129 | 0.126 |
| 424 | 0.147 | 0.123 | 0.946 | 0.131 | 0.126 |
| 425 | 0.149 | 0.123 | 0.936 | 0.133 | 0.132 |
| 426 | 0.151 | 0.123 | 0.926 | 0.135 | 0.133 |
| 427 | 0.153 | 0.123 | 0.916 | 0.137 | 0.134 |
| 428 | 0.155 | 0.123 | 0.906 | 0.139 | 0.135 |
| 429 | 0.157 | 0.123 | 0.897 | 0.141 | 0.136 |
| 430 | 0.164 | 0.126 | 0.887 | 0.143 | 0.137 |
| 431 | 0.166 | 0.126 | 0.868 | 0.145 | 0.138 |
| 432 | 0.166 | 0.132 | 0.857 | 0.147 | 0.139 |
| 433 | 0.171 | 0.133 | 0.845 | 0.149 | 0.140 |
| 434 | 0.176 | 0.134 | 0.833 | 0.151 | 0.141 |
| 435 | 0.181 | 0.135 | 0.821 | 0.153 | 0.142 |
| 436 | 0.186 | 0.136 | 0.808 | 0.155 | 0.144 |
| 437 | 0.191 | 0.137 | 0.795 | 0.157 | 0.146 |
| 438 | 0.196 | 0.138 | 0.778 | 0.164 | 0.148 |
| 439 | 0.201 | 0.139 | 0.768 | 0.166 | 0.150 |
| 440 | 0.206 | 0.140 | 0.759 | 0.166 | 0.152 |
| 441 | 0.212 | 0.141 | 0.749 | 0.171 | 0.154 |
| 442 | 0.218 | 0.142 | 0.729 | 0.176 | 0.156 |
| 443 | 0.224 | 0.144 | 0.709 | 0.181 | 0.158 |
| 444 | 0.230 | 0.146 | 0.690 | 0.186 | 0.160 |
| 445 | 0.236 | 0.148 | 0.675 | 0.191 | 0.162 |
| 446 | 0.242 | 0.150 | 0.660 | 0.196 | 0.164 |
| 447 | 0.250 | 0.152 | 0.645 | 0.201 | 0.166 |
| 448 | 0.258 | 0.154 | 0.631 | 0.206 | 0.167 |
| 449 | 0.266 | 0.156 | 0.616 | 0.212 | 0.169 |
| 450 | 0.274 | 0.158 | 0.606 | 0.218 | 0.171 |
| 451 | 0.282 | 0.160 | 0.591 | 0.224 | 0.174 |
| 452 | 0.290 | 0.162 | 0.576 | 0.230 | 0.178 |
| 453 | 0.298 | 0.164 | 0.562 | 0.236 | 0.182 |
| 454 | 0.306 | 0.166 | 0.547 | 0.242 | 0.186 |
| 455 | 0.314 | 0.167 | 0.532 | 0.250 | 0.190 |
| 456 | 0.322 | 0.169 | 0.517 | 0.258 | 0.194 |
| 457 | 0.332 | 0.171 | 0.502 | 0.266 | 0.198 |
| 458 | 0.340 | 0.174 | 0.488 | 0.274 | 0.202 |
| 459 | 0.350 | 0.178 | 0.473 | 0.282 | 0.206 |
| 460 | 0.358 | 0.182 | 0.458 | 0.290 | 0.210 |
| 461 | 0.368 | 0.186 | 0.433 | 0.298 | 0.214 |
| 462 | 0.376 | 0.190 | 0.404 | 0.306 | 0.218 |
| 463 | 0.384 | 0.194 | 0.384 | 0.314 | 0.222 |
| 464 | 0.392 | 0.198 | 0.369 | 0.322 | 0.228 |
| 465 | 0.400 | 0.202 | 0.358 | 0.332 | 0.233 |
| 466 | 0.408 | 0.206 | 0.346 | 0.340 | 0.239 |
| 467 | 0.416 | 0.210 | 0.334 | 0.350 | 0.245 |
| 468 | 0.424 | 0.214 | 0.322 | 0.358 | 0.251 |
| 469 | 0.432 | 0.218 | 0.305 | 0.368 | 0.257 |
| 470 | 0.440 | 0.222 | 0.276 | 0.376 | 0.266 |
| 471 | 0.448 | 0.228 | 0.251 | 0.384 | 0.275 |
| 472 | 0.456 | 0.233 | 0.239 | 0.392 | 0.284 |
| 473 | 0.464 | 0.239 | 0.228 | 0.400 | 0.293 |
| 474 | 0.472 | 0.245 | 0.216 | 0.408 | 0.300 |
| 475 | 0.481 | 0.251 | 0.204 | 0.416 | 0.307 |
| 476 | 0.490 | 0.257 | 0.192 | 0.424 | 0.315 |
| 477 | 0.500 | 0.266 | 0.184 | 0.432 | 0.320 |
| 478 | 0.513 | 0.275 | 0.176 | 0.440 | 0.327 |
| 479 | 0.525 | 0.284 | 0.168 | 0.448 | 0.335 |
| 480 | 0.535 | 0.293 | 0.161 | 0.456 | 0.342 |
| 481 | 0.538 | 0.300 | 0.153 | 0.464 | 0.348 |
| 482 | 0.551 | 0.307 | 0.145 | 0.472 | 0.354 |
| 483 | 0.564 | 0.315 | 0.137 | 0.481 | 0.363 |
| 484 | 0.577 | 0.320 | 0.129 | 0.490 | 0.369 |
| 485 | 0.590 | 0.327 | 0.121 | 0.500 | 0.377 |
| 486 | 0.603 | 0.335 | 0.113 | 0.513 | 0.385 |
| 487 | 0.616 | 0.342 | 0.105 | 0.525 | 0.393 |
| 488 | 0.629 | 0.348 | 0.098 | 0.535 | 0.401 |
| 489 | 0.642 | 0.354 | 0.090 | 0.538 | 0.409 |
| 490 | 0.655 | 0.363 | 0.082 | 0.551 | 0.417 |
| 491 | 0.668 | 0.369 | 0.080 | 0.564 | 0.425 |
| 492 | 0.681 | 0.377 | 0.074 | 0.577 | 0.433 |
| 493 | 0.694 | 0.385 | 0.070 | 0.590 | 0.440 |
| 494 | 0.707 | 0.393 | 0.066 | 0.603 | 0.448 |
| 495 | 0.720 | 0.401 | 0.062 | 0.616 | 0.456 |
| 496 | 0.733 | 0.409 | 0.058 | 0.629 | 0.464 |
| 497 | 0.746 | 0.417 | 0.054 | 0.642 | 0.472 |
| 498 | 0.759 | 0.425 | 0.050 | 0.655 | 0.480 |
| 499 | 0.772 | 0.433 | 0.046 | 0.668 | 0.488 |
| 500 | 0.785 | 0.440 | 0.042 | 0.681 | 0.500 |
| 501 | 0.798 | 0.448 | 0.038 | 0.694 | 0.515 |
| 502 | 0.820 | 0.456 | 0.034 | 0.707 | 0.527 |
| 503 | 0.840 | 0.464 | 0.033 | 0.720 | 0.537 |
| 504 | 0.850 | 0.472 | 0.031 | 0.733 | 0.550 |
| 505 | 0.856 | 0.480 | 0.029 | 0.746 | 0.565 |
| 506 | 0.867 | 0.488 | 0.027 | 0.759 | 0.577 |
| 507 | 0.878 | 0.500 | 0.025 | 0.772 | 0.590 |
| 508 | 0.889 | 0.515 | 0.023 | 0.785 | 0.603 |
| 509 | 0.899 | 0.527 | 0.021 | 0.798 | 0.616 |
| 510 | 0.908 | 0.537 | 0.021 | 0.820 | 0.629 |
| 511 | 0.917 | 0.550 | 0.021 | 0.840 | 0.641 |
| 512 | 0.926 | 0.565 | 0.020 | 0.850 | 0.654 |
| 513 | 0.934 | 0.577 | 0.020 | 0.856 | 0.667 |
| 514 | 0.942 | 0.590 | 0.020 | 0.867 | 0.680 |
| 515 | 0.949 | 0.603 | | 0.878 | 0.693 |
| 516 | 0.956 | 0.616 | | 0.889 | 0.705 |
| 517 | 0.962 | 0.629 | | 0.899 | 0.718 |
| 518 | 0.968 | 0.641 | | 0.908 | 0.731 |
| 519 | 0.973 | 0.654 | | 0.917 | 0.744 |
| 520 | 0.978 | 0.667 | | 0.926 | 0.757 |
| 521 | 0.983 | 0.680 | | 0.934 | 0.769 |
| 522 | 0.986 | 0.693 | | 0.942 | 0.782 |
| 523 | 0.990 | 0.705 | | 0.949 | 0.795 |
| 524 | 0.993 | 0.718 | | 0.956 | 0.801 |
| 525 | 0.995 | 0.731 | | 0.962 | 0.814 |
| 526 | 0.997 | 0.744 | | 0.968 | 0.825 |
| 527 | 0.999 | 0.757 | | 0.973 | 0.835 |
| 528 | 0.999 | 0.769 | | 0.978 | 0.847 |
| 529 | 1.000 | 0.782 | | 0.983 | 0.858 |
| 530 | 1.000 | 0.795 | | 0.986 | 0.869 |
| 531 | 0.999 | 0.801 | | 0.990 | 0.880 |
| 532 | 0.998 | 0.814 | | 0.993 | 0.890 |
| 533 | 0.997 | 0.825 | | 0.995 | 0.900 |
| 534 | 0.995 | 0.835 | | 0.997 | 0.910 |
| 535 | 0.992 | 0.847 | | 0.999 | 0.919 |
| 536 | 0.989 | 0.858 | | 0.999 | 0.927 |
| 537 | 0.986 | 0.869 | | 1.000 | 0.935 |
| 538 | 0.982 | 0.880 | | 1.000 | 0.943 |
| 539 | 0.977 | 0.890 | | 0.999 | 0.950 |
| 540 | 0.973 | 0.900 | | 0.998 | 0.956 |
| 541 | 0.967 | 0.910 | | 0.997 | 0.963 |
| 542 | 0.961 | 0.919 | | 0.995 | 0.968 |
| 543 | 0.955 | 0.927 | | 0.992 | 0.974 |
| 544 | 0.948 | 0.935 | | 0.989 | 0.978 |
| 545 | 0.941 | 0.943 | | 0.986 | 0.983 |
| 546 | 0.933 | 0.950 | | 0.982 | 0.987 |
| 547 | 0.923 | 0.956 | | 0.977 | 0.990 |
| 548 | 0.912 | 0.963 | | 0.973 | 0.993 |
| 549 | 0.897 | 0.968 | | 0.967 | 0.995 |
| 550 | 0.887 | 0.974 | | 0.961 | 0.997 |
| 551 | 0.877 | 0.978 | | 0.955 | 0.999 |
| 552 | 0.866 | 0.983 | | 0.948 | 1.000 |
| 553 | 0.855 | 0.987 | | 0.941 | 1.000 |
| 554 | 0.843 | 0.990 | | 0.933 | 1.000 |
| 555 | 0.831 | 0.993 | | 0.923 | 0.999 |
| 556 | 0.818 | 0.995 | | 0.912 | 0.998 |
| 557 | 0.805 | 0.997 | | 0.897 | 0.997 |
| 558 | 0.792 | 0.999 | | 0.887 | 0.995 |
| 559 | 0.778 | 1.000 | | 0.877 | 0.990 |
| 560 | 0.771 | 1.000 | | 0.866 | 0.986 |
| 561 | 0.764 | 1.000 | | 0.855 | 0.982 |
| 562 | 0.749 | 0.999 | | 0.843 | 0.978 |
| 563 | 0.734 | 0.998 | | 0.831 | 0.973 |
| 564 | 0.719 | 0.997 | | 0.818 | 0.968 |
| 565 | 0.704 | 0.995 | | 0.805 | 0.962 |
| 566 | 0.688 | 0.992 | | 0.792 | 0.956 |
| 567 | 0.671 | 0.990 | | 0.778 | 0.949 |
| 568 | 0.655 | 0.986 | | 0.771 | 0.942 |
| 569 | 0.640 | 0.982 | | 0.764 | 0.934 |
| 570 | 0.625 | 0.978 | | 0.749 | 0.926 |
| 571 | 0.610 | 0.973 | | 0.734 | 0.917 |
| 572 | 0.595 | 0.968 | | 0.719 | 0.908 |
| 573 | 0.580 | 0.962 | | 0.704 | 0.899 |
| 574 | 0.565 | 0.956 | | 0.688 | 0.889 |
| 575 | 0.550 | 0.949 | | 0.671 | 0.879 |
| 576 | 0.535 | 0.942 | | 0.655 | 0.868 |
| 577 | 0.520 | 0.934 | | 0.640 | 0.857 |
| 578 | 0.505 | 0.926 | | 0.625 | 0.845 |
| 579 | 0.490 | 0.917 | | 0.610 | 0.833 |
| 580 | 0.475 | 0.908 | | 0.595 | 0.821 |
| 581 | 0.460 | 0.899 | | 0.580 | 0.808 |
| 582 | 0.445 | 0.889 | | 0.565 | 0.795 |
| 583 | 0.430 | 0.879 | | 0.550 | 0.778 |
| 584 | 0.415 | 0.868 | | 0.535 | 0.768 |
| 585 | 0.400 | 0.857 | | 0.520 | 0.759 |
| 586 | 0.385 | 0.845 | | 0.505 | 0.749 |
| 587 | 0.370 | 0.833 | | 0.490 | 0.729 |
| 588 | 0.355 | 0.821 | | 0.475 | 0.709 |
| 589 | 0.340 | 0.808 | | 0.460 | 0.690 |
| 590 | 0.328 | 0.795 | | 0.445 | 0.675 |
| 591 | 0.316 | 0.778 | | 0.430 | 0.660 |
| 592 | 0.304 | 0.768 | | 0.415 | 0.645 |
| 593 | 0.292 | 0.759 | | 0.400 | 0.631 |
| 594 | 0.280 | 0.749 | | 0.385 | 0.616 |
| 595 | 0.268 | 0.739 | | 0.370 | 0.606 |
| 596 | 0.256 | 0.729 | | 0.355 | 0.591 |
| 597 | 0.244 | 0.709 | | 0.340 | 0.576 |
| 598 | 0.232 | 0.690 | | 0.328 | 0.562 |
| 599 | 0.220 | 0.675 | | 0.316 | 0.547 |
| 600 | 0.208 | 0.660 | | 0.304 | 0.532 |
| 601 | 0.200 | 0.645 | | 0.292 | 0.517 |
| 602 | 0.192 | 0.631 | | 0.280 | 0.502 |
| 603 | 0.184 | 0.616 | | 0.268 | 0.488 |
| 604 | 0.176 | 0.606 | | 0.256 | 0.473 |
| 605 | 0.170 | 0.591 | | 0.244 | 0.458 |
| 606 | 0.164 | 0.576 | | 0.232 | 0.443 |
| 607 | 0.158 | 0.562 | | 0.220 | 0.429 |
| 608 | 0.152 | 0.547 | | 0.208 | 0.414 |
| 609 | 0.146 | 0.532 | | 0.200 | 0.399 |
| 610 | 0.140 | 0.517 | | 0.192 | 0.384 |
| 611 | 0.134 | 0.502 | | 0.184 | 0.369 |
| 612 | 0.128 | 0.488 | | 0.176 | 0.358 |
| 613 | 0.122 | 0.473 | | 0.170 | 0.346 |
| 614 | 0.116 | 0.458 | | 0.164 | 0.334 |
| 615 | 0.110 | 0.443 | | 0.158 | 0.322 |
| 616 | 0.104 | 0.429 | | 0.152 | 0.310 |
| 617 | 0.098 | 0.414 | | 0.146 | 0.299 |
| 618 | 0.092 | 0.399 | | 0.140 | 0.287 |
| 619 | 0.086 | 0.384 | | 0.134 | 0.275 |
| 620 | 0.080 | 0.369 | | 0.128 | 0.263 |
| 621 | 0.076 | 0.358 | | 0.122 | 0.251 |
| 622 | 0.072 | 0.346 | | 0.116 | 0.239 |
| 623 | 0.068 | 0.334 | | 0.110 | 0.228 |
| 624 | 0.064 | 0.322 | | 0.104 | 0.216 |
| 625 | 0.060 | 0.310 | | 0.098 | 0.204 |
| 626 | 0.056 | 0.299 | | 0.092 | 0.192 |
| 627 | 0.052 | 0.287 | | 0.086 | 0.184 |
| 628 | 0.048 | 0.275 | | 0.080 | 0.176 |
| 629 | 0.044 | 0.263 | | 0.076 | 0.168 |
| 630 | 0.040 | 0.251 | | 0.072 | 0.161 |
| 631 | 0.038 | 0.239 | | 0.068 | 0.153 |
| 632 | 0.036 | 0.228 | | 0.064 | 0.145 |
| 633 | 0.034 | 0.216 | | 0.060 | 0.137 |
| 634 | 0.032 | 0.204 | | 0.056 | 0.133 |
| 635 | 0.030 | 0.192 | | 0.052 | 0.129 |
| 636 | 0.028 | 0.184 | | 0.048 | 0.125 |
| 637 | 0.026 | 0.176 | | 0.044 | 0.121 |
| 638 | 0.024 | 0.168 | | 0.040 | 0.117 |
| 639 | 0.022 | 0.161 | | 0.038 | 0.113 |
| 640 | 0.020 | 0.153 | | 0.036 | 0.109 |
| 641 | 0.018 | 0.145 | | 0.034 | 0.105 |
| 642 | 0.016 | 0.137 | | 0.032 | 0.101 |
| 643 | 0.014 | 0.129 | | 0.030 | 0.098 |
| 644 | 0.014 | 0.121 | | 0.028 | 0.093 |
| 645 | 0.013 | 0.113 | | 0.026 | 0.088 |
| 646 | 0.012 | 0.105 | | 0.024 | 0.083 |
| 647 | 0.012 | 0.098 | | 0.022 | 0.078 |
| 648 | 0.011 | 0.090 | | 0.020 | 0.073 |
| 649 | 0.011 | 0.082 | | 0.018 | 0.068 |
| 650 | 0.010 | 0.080 | | 0.016 | 0.063 |
| 651 | 0.010 | 0.074 | | 0.014 | 0.058 |
| 652 | 0.009 | 0.070 | | 0.014 | 0.053 |
| 653 | 0.009 | 0.066 | | 0.013 | 0.052 |
| 654 | 0.008 | 0.062 | | 0.012 | 0.050 |
| 655 | 0.008 | 0.058 | | 0.012 | 0.049 |
| 656 | 0.007 | 0.054 | | 0.011 | 0.047 |
| 657 | 0.007 | 0.050 | | 0.011 | 0.046 |
| 658 | 0.006 | 0.046 | | 0.010 | 0.044 |
| 659 | 0.006 | 0.042 | | 0.010 | 0.043 |
| 660 | 0.005 | 0.038 | | 0.009 | 0.041 |
| 661 | 0.005 | 0.034 | | 0.009 | 0.040 |
| 662 | 0.004 | 0.033 | | 0.008 | 0.038 |
| 663 | 0.004 | 0.031 | | 0.008 | 0.037 |
| 664 | 0.003 | 0.029 | | 0.007 | 0.035 |
| 665 | 0.003 | 0.027 | | 0.007 | 0.034 |
| 666 | 0.003 | 0.025 | | 0.006 | 0.033 |
| 667 | 0.003 | 0.023 | | 0.006 | 0.031 |
| 668 | 0.003 | 0.021 | | 0.005 | 0.030 |
| 669 | 0.003 | 0.019 | | 0.005 | 0.028 |
| 670 | 0.003 | 0.017 | | 0.004 | 0.027 |
| 671 | 0.003 | 0.015 | | 0.004 | 0.025 |
| 672 | 0.003 | 0.013 | | 0.003 | 0.024 |
| 673 | 0.003 | 0.011 | | 0.003 | 0.022 |
| 674 | 0.003 | 0.009 | | 0.003 | 0.021 |
| 675 | 0.003 | 0.008 | | 0.003 | 0.019 |

In some embodiments, a luminescent compound may absorb at about 530 nm to about 540 nm, about 534 nm to about 537 nm, about 535 nm to about 536 nm, about 545 nm to about 565 nm, about 549 nm to about 562 nm, about 535 nm, about 536 nm, about 549 nm, about 557 nm, or about 562 nm; and may have a transmittance of less than about 90%, about 85%, or about 80% in one of those ranges.

In some embodiments, a luminescent compound may absorb at about 540 nm to about 550 nm, about 545 nm to about 550 nm, or about 547 nm; and/or may emit at about 560 nm to about 580 nm, about 565 nm to about 575 nm, or about 569 nm.

The amount of luminescent compound present in the composition can vary. Any amount of luminescent compound that increases the emission of the first visible color wavelength, increases the emission of the second visible color wavelength, further separates the peak emissive wavelength of the first color wavelength from the second color wavelength or both increases and separates the peak emissive wavelengths in the optical element, such that the first visible color wavelength is more easily discerned to a color blind individual, is suitable. In one embodiment, the luminescent compound is present in an amount selected to provide a transmittance that is greater than 90% at the first visible wavelength in the optical element. This is surprising, particularly if the optical element also comprises a light absorbing dye.

Luminescent Compound

The luminescent compound used in the composition can vary. In an embodiment, the luminescent compound comprises a rhodamine or a rhodamine derivative dye, such as an optionally substituted rhodamine, including optionally substituted rhodamine 110, optionally substituted rhodamine 123, optionally substituted rhodamine 6G, optionally substituted rhodamine 116, optionally substituted rhodamine B, optionally substituted rhodamine 3B, optionally substituted rhodamine 19, etc., or a combination thereof.

Unless otherwise indicated, any reference to a compound herein by structure, name, or any other means, includes salts, including zwitterionic forms; alternate solid forms, such as polymorphs, solvates, hydrates, etc.; tautomers; or any other chemical species that may rapidly convert to a compound described herein under conditions in which the compounds are used as described herein.

Any structure or name for a compound used herein may refer to any stereoisomer or any mixture of stereoisomers.

Unless otherwise indicated, when a compound or chemical structural feature such as alkyl, cycloalkyl, alkoxy, alkoxyalkyl, aryl, arylalkyl, perylene, etc., is referred to as being “optionally substituted,” it includes a feature that has no substituents (i.e. “unsubstituted”), or a feature that is “substituted,” meaning that the feature has one or more substituents. The term “substituent” has the ordinary meaning known to one of ordinary skill in the art and includes a moiety that replaces one or more hydrogen atoms attached to a parent compound or structural feature. In some embodiments, the substituent may be an ordinary organic moiety known in the art, which may have a molecular weight (e.g. the sum of the atomic masses of the atoms of the substituent) of 15 g/mol to 50 g/mol, 15 g/mol to 100 g/mol, 15 g/mol to 150 g/mol, 15 g/mol to 200 g/mol, 15 g/mol to 300 g/mol, or 15 g/mol to 500 g/mol. In some embodiments, the substituent comprises: 0-30, 0-20, 0-10, or 0-5 carbon atoms; and 0-30, 0-20, 0-10, or 0-5 heteroatoms, wherein each heteroatom is independently: N, O, S, Si, F, Cl, Br, or I; provided that the substituent comprises at least one atom that is not hydrogen, e.g.: C, N, O, S, Si, F, Cl, Br, or I. In some embodiments, a substituent may consist of 1, 2, 3, 4, 5, 6, 7, 8, 9, 10, 11, or 12 non-hydrogen atoms and any necessary hydrogen atoms. Some non-hydrogen atoms may include C, N, O, S, Si, F, Cl, Br, I, P, etc.

Examples of substituents include, but are not limited to, alkyl (including linear, branched, and cycloalkyl), alkenyl (including linear, branched, and cycloalkenyl), alkynyl (including linear, branched, and cyclo alkynyl), heteroalkyl, heteroalkenyl, heteroalkynyl, aryl, heterocyclic substituents (including heteroaryl and heteroalicyclic substituents), hydroxy, protected hydroxy, alkoxy, aryloxy, acyl, acyloxy, alkylcarboxylate, carboxylate, thiol, alkylthio, arylthio, cyano, halo, carbonyl, thiocarbonyl, O-carbamyl, N-carbamyl, O-thiocarbamyl, N-thiocarbamyl, C-amido, N-amido, S-sulfonamido, N-sulfonamido, isocyanato, thiocyanato, isothiocyanato, nitro, silyl, sulfenyl, sulfinyl, sulfonyl, haloalkyl, haloalkoxyl, trihalomethanesulfonyl, trihalomethanesulfonamido, and amino, including mono- and di-substituted amino groups, and the protected derivatives thereof, etc., or a combination thereof. The term “combination thereof” in the previous list indicates that substituents may also include a combination of any of the above substituents, wherein a hydrogen atom of one substituent is replaced by another substituent. For example, substituents may be a combination of alkyl and aryl (e.g. arylalkyl such as CH₂-phenyl, or heteroarylalkyl such as C₂H₄-heteraryl, etc.), alkyl and a heterocyclic substituent (e.g. heterocyclylalkyl), alkyl and alkoxy (e.g. CH₂OCH₃), alkyl and halo (e.g. C₂H₄Cl, C₃H₆F, etc.), acyl and hydroxyl (e.g. —COCH₂OH), etc.

For convenience, the term “molecular weight” is used with respect to a moiety or part of a molecule to indicate the sum of the atomic masses of the atoms in the moiety or part of a molecule, even though it may not be a complete molecule. “Molecular weight” may also refer to complete molecules.

Structures associated with some of the chemical names referred to herein are depicted below. These structures may be unsubstituted, as shown below, or a substituent may independently be in any position normally occupied by a hydrogen atom when the structure is unsubstituted. Unless a point of attachment is indicated by [symbol] , attachment may occur at any position normally occupied by a hydrogen atom.

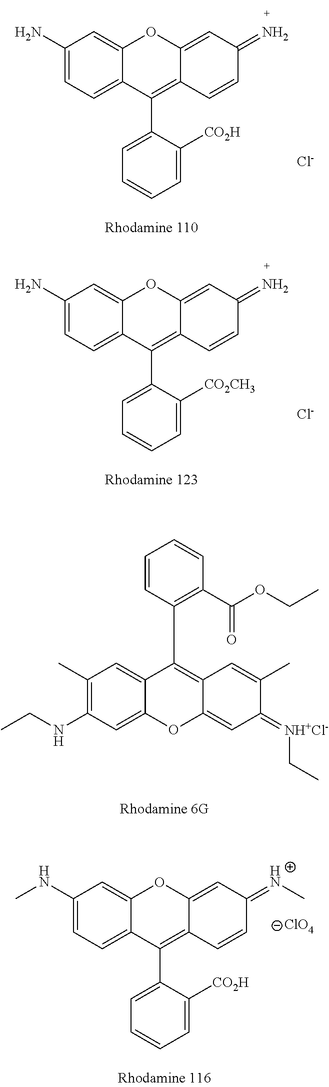

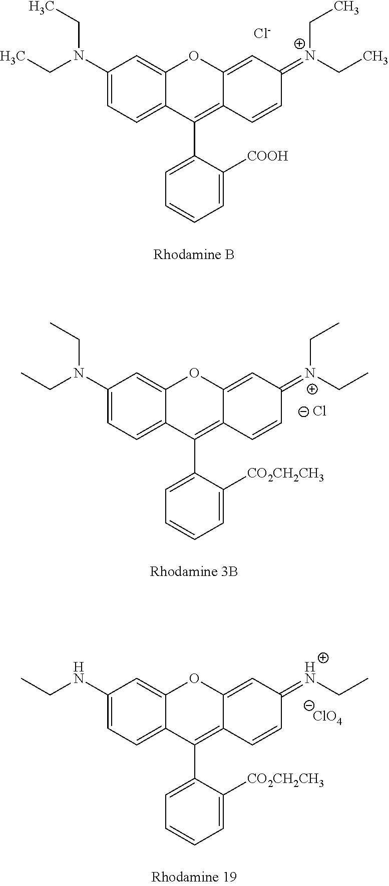

As used herein the term “alkyl” has the broadest meaning generally understood in the art and may include a moiety composed of carbon and hydrogen containing no double or triple bonds. Alkyl may be linear alkyl, branched alkyl, cycloalkyl, or a combination thereof, and in some embodiments, may contain from one to thirty-five carbon atoms. In some embodiments, alkyl may include C₁₋₁₀ linear alkyl, such as methyl (—CH₃), ethyl (—CH₂CH₃), n-propyl (—CH₂CH₂CH₃), n-butyl (—CH₂CH₂CH₂CH₃), n-pentyl (—CH₂CH₂CH₂CH₂CH₃), n-hexyl (—CH₂CH₂CH₂CH₂CH₂CH₃), etc.; C₃₋₁₀ branched alkyl, such as C₃H₇ (e.g. iso-propyl), C₄H₉ (e.g. branched butyl isomers), C₅H₁₁ (e.g. branched pentyl isomers), C₆H₁₃ (e.g. branched hexyl isomers), C₇H₁₅ (e.g. heptyl isomers), etc.; C₃₋₁₀ cycloalkyl, such as C₃H₅ (e.g. cyclopropyl), C₄H₇ (e.g. cyclobutyl isomers such as cyclobutyl, methylcyclopropyl, etc.), C₅H₉ (e.g. cyclopentyl isomers such as cyclopentyl, methylcyclobutyl, dimethylcyclopropyl, etc.) C₆H₁₁ (e.g. cyclohexyl isomers), C₇H₁₃ (e.g. cycloheptyl isomers), etc.; and the like. In some embodiments, and alkyl group may include methyl, ethyl, n-propyl, isopropyl, n-butyl, isobutyl, sec-butyl, tert-butyl, isohexyl, isooctyl, 2-ethyl-hexyl, etc.

An alkoxy group may also be linear, branched, or cyclic. Some examples of useful alkoxy groups include methoxy, ethoxy, propoxy, and butoxy. An alkoxyalkyl group may also be linear or branched. Some examples of useful alkoxyalkyl groups include methoxymethyl, methoxyethyl, methoxypropyl, ethoxymethyl, ethoxyethyl, ethoxypropyl, propoxymethyl, propoxyethyl, and propoxypropyl.

Some examples of useful cycloalkyl groups include cyclopentyl, cyclohexyl, or cyloheptyl. Some examples of useful aryl groups include phenyl, diphenyl, tolyl, naphthyl, phenanthryl, and anthracenyl. Some examples of useful arylalkyl groups include benzyl, phenethyl, diphenylmethyl, trityl, naphthylmethyl, phenanthylmethyl, and anthranylmethyl.

In some embodiments, a luminescent compound may be an optionally substituted rhodamine or a rhodamine derivative, such as a compound of any of Formula 1, Formula 2, or Formula 3:

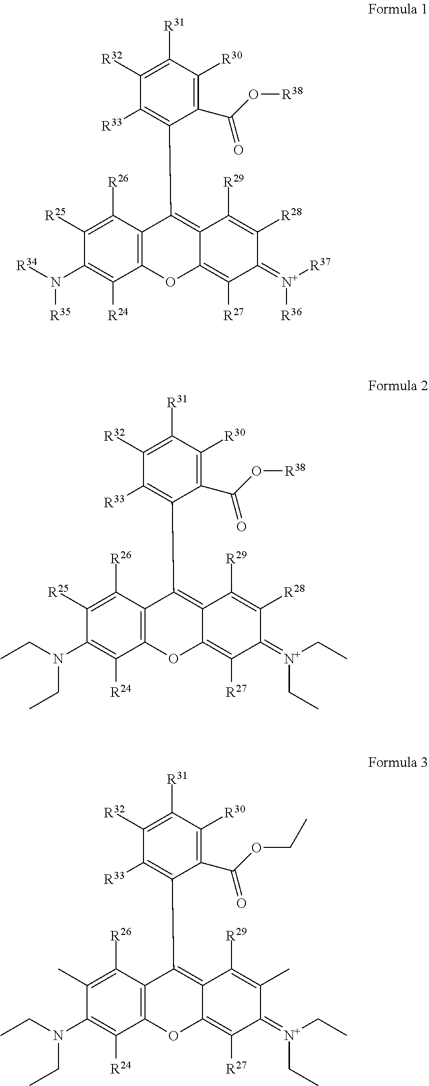

Generally, R²⁴—R³³, may be H or any substituent, such as a substituent having from 0 to 6 carbon atoms and from 0 to 5 heteroatoms independently selected from: O, N, S, F, Cl, Br, and I, and/or having a molecular weight of 15 g/mol to 300 g/mol. In some embodiments R²⁴—R³³ may have 1, 2, 3, 4, 5, 6, 7, 8, 9, or 10 carbon atoms, 0 or 1 nitrogen atoms, and/or 0 or 1 sulfur atoms. Any of R²⁴-R³³ may comprise: a) 1 or more alkyl moieties optionally substituted with, or optionally connected by or to, b) 1 or more functional groups, such as C═C, C≡C, CO, CO₂, CON, NCO₂, OH, SH, O, S, N, N═C, F, Cl, Br, I, CN, NO₂, CO₂H, NH₂, etc.; or may be substituent having no alkyl portion, such as F, Cl, Br, I, NO₂, CN, NH₂, OH, COH, CO₂H, etc.

With respect to any relevant formula or structural depiction above, some non-limiting examples of R²⁴ may include R^{A}, F, Cl, CN, OR^{A}, CF₃, NO₂, NR^{A}R^{B}, COR^{A}, CO₂R^{A}, OCOR^{A}, NR^{A}COR^{B}, CONR^{A}R^{B}, etc. In some embodiments, R²⁴ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc. In some embodiments, R²⁴ may be H.

Each R^{A} in any formula or structural depiction herein may independently be H, or C₁₋₁₂ alkyl, including: linear or branched alkyl having a formula CₐH₍₂ₐ₊₁₎; or cyclo-alkyl having a formula CₐH₍₂ₐ₋₁₎; wherein a is 1, 2, 3, 4, 5, 6, 7, 8, 9, 10, 11, or 12, such as linear or branched alkyl of a formula CH₃, C₂H₅, C₃H₇, C₄H₉, C₅H₁₁, C₆H₁₃, C₇H₁₅, C₈H₁₇, C₉H₁₉, C₁₀H₂₁, etc., or cycloalkyl of a formula: C₃H₅, C₄H₇, C₅H₉, C₆H₁₁, C₇H₁₃, C₈H₁₅, C₉H₁₇, C₁₀H₁₉, etc.

Each R^{B} in any formula or structural depiction herein may independently be H, or C₁₋₁₂ alkyl, including: linear or branched alkyl having a formula CₐH₍₂ₐ₊₁₎; or cyclo-alkyl having a formula CₐH₍₂ₐ₋₁₎; wherein a is 1, 2, 3, 4, 5, 6, 7, 8, 9, 10, 11, or 12, such as linear or branched alkyl of a formula CH₃, C₂H₅, C₃H₇, C₄H₉, C₅H₁₁, C₆H₁₃, C₇H₁₅, C₈H₁₇, C₉H₁₉, C₁₀H₂₁, etc., or cycloalkyl of a formula: C₃H₅, C₄H₇, C₅H₉, C₆H₁₁, C₇H₁₃, C₈H₁₅, C₉H₁₇, C₁₀H₁₉, etc.

With respect to any relevant formula or structural depiction above, some non-limiting examples of R²⁵ may include R^{A}, F, Cl, CN, OR^{A}, CF₃, NO₂, NR^{A}R^{B}, COR^{A}, CO₂R^{A}, OCOR^{A}, NR^{A}COR^{B}, CONR^{A}R^{B}, etc. In some embodiments, R²⁵ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc. In some embodiments, R²⁵ may be H or CH₃.

With respect to any relevant formula or structural depiction above, some non-limiting examples of R²⁶ may include R^{A}, F, Cl, CN, OR^{A}, CF₃, NO₂, NR^{A}R^{B}, COR^{A}, CO₂R^{A}, OCOR^{A}, NR^{A}COR^{B}, CONR^{A}R^{B}, etc. In some embodiments, R²⁶ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc. In some embodiments, R²⁶ may be H.

With respect to any relevant formula or structural depiction above, some non-limiting examples of R²⁷ may include R^{A}, F, Cl, CN, OR^{A}, CF₃, NO₂, NR^{A}R^{B}, COR^{A}, CO₂R^{A}, OCOR^{A}, NR^{A}COR^{B}, CONR^{A}R^{B}, etc. In some embodiments, R²⁷ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc. In some embodiments, R²⁷ may be H.

With respect to any relevant formula or structural depiction above, some non-limiting examples of R²⁸ may include R^{A}, F, Cl, CN, OR^{A}, CF₃, NO₂, NR^{A}R^{B}, COR^{A}, CO₂R^{A}, OCOR^{A}, NR^{A}COR^{B}, CONR^{A}R^{B}, etc. In some embodiments, R²⁸ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc. In some embodiments, R²⁸ may be H or CH₃.

In some embodiments both R²⁵ and R²⁸ may be H or both R²⁵ and R²⁸ may be CH₃.

With respect to any relevant formula or structural depiction above, some non-limiting examples of R²⁹ may include R^{A}, F, Cl, CN, OR^{A}, CF₃, NO₂, NR^{A}R^{B}, COR^{A}, CO₂R^{A}, OCOR^{A}, NR^{A}COR^{B}, CONR^{A}R^{B}, etc. In some embodiments, R²⁹ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc. In some embodiments, R²⁹ may be H.

With respect to any relevant formula or structural depiction above, some non-limiting examples of R³⁰ may include R^{A}, F, Cl, CN, OR^{A}, CF₃, NO₂, NR^{A}R^{B}, COR^{A}, CO₂R^{A}, OCORA, NR^{A}COR^{B}, CONR^{A}R^{B}, etc. In some embodiments, R³⁰ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc. In some embodiments, R³⁰ may be H.

With respect to any relevant formula or structural depiction above, some non-limiting examples of R³¹ may include R^{A}, F, Cl, CN, OR^{A}, CF₃, NO₂, NR^{A}R^{B}, COR^{A}, CO₂R^{A}, OCORA, NR^{A}COR^{B}, CONR^{A}R^{B}, etc. In some embodiments, R³¹ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc. In some embodiments, R³¹ may be H.

With respect to any relevant formula or structural depiction above, some non-limiting examples of R³² may include R^{A}, F, Cl, CN, OR^{A}, CF₃, NO₂, NR^{A}R^{B}, COR^{A}, CO₂R^{A}, OCORA, NR^{A}COR^{B}, CONR^{A}R^{B}, etc. In some embodiments, R³² may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc. In some embodiments, R³² may be H.

With respect to any relevant formula or structural depiction above, some non-limiting examples of R³³ may include R^{A}, F, Cl, CN, OR^{A}, CF₃, NO₂, NR^{A}R^{B}, COR^{A}, CO₂R^{A}, OCORA, NR^{A}COR^{B}, CONR^{A}R^{B}, etc. In some embodiments, R³³ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc. In some embodiments, R³³ may be H.

With respect to any relevant formula or structural depiction above, some non-limiting examples of R³⁴ may include R^{A} or CF₃. In some embodiments, R³⁴ may be H or C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc. In some embodiments, R³⁴ may be H; CH₃, or CH₂CH₃.

With respect to any relevant formula or structural depiction above, some non-limiting examples of R³⁵ may include R^{A} or CF₃. In some embodiments, R³⁵ may be H or C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc. In some embodiments, R³⁵ may be H, CH₃, or CH₂CH₃.

In some embodiments, R³⁴ and R³⁵ are both H or CH₃, or R³⁴ is H and R³⁵ is CH₃ or CH₂CH₃.

With respect to any relevant formula or structural depiction above, some non-limiting examples of R³⁶ may include R^{A} or CF₃. In some embodiments, R³⁶ may be H or C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc. In some embodiments, R³⁶ may be H, CH₃, or CH₂CH₃.

With respect to any relevant formula or structural depiction above, some non-limiting examples of R³⁷ may include R^{A} or CF₃. In some embodiments, R³⁷ may be H or C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc. In some embodiments, R³⁷ may be H, CH₃, or CH₂CH₃.

In some embodiments, R³⁶ and R³⁷ are both H or CH₃, or R³⁶ is H and R³⁷ is CH₃ or CH₂CH₃.

With respect to any relevant formula or structural depiction above, some non-limiting examples of R³⁸ may include R^{A}. In some embodiments, R³⁸ may be H or C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc. In some embodiments, R³⁸ may be H, CH₃, or CH₂CH₃.

In some embodiments, a luminescent compound may be polymerized into the matrix material. For example, the matrix material may comprise repeat units that contain a luminescent group as a pendant group. While there are many ways that a luminescent compound may be polymerized into a matrix material, in some embodiments, a luminescent compound has a polymerizable substituent, or is a polymerized derivative of the polymerizable substituent. In some embodiments, any of R²⁴⁻³⁸ may be a substituted vinyl, a substituted acrylate, a substituted alkacrylate, an epoxide, a polyol, a polyisocyanate, or a corresponding polymerized derivative thereof. In some embodiments, any of R²⁴⁻³⁸ may be polymerizable substituent M1, M2, or M3, or polymerized derivative thereof P1, P2, P3, shown in Table 2 below:

TABLE 2

| | Any of R²⁴⁻³⁸ | Any of R²⁴⁻³⁸ | Any of R²⁴⁻³⁸ |
|---|---|---|---|
| Polymerizable substituent | 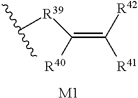 | 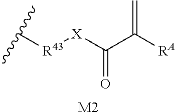 | 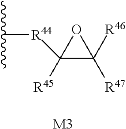 |
| Polymerized derivative | 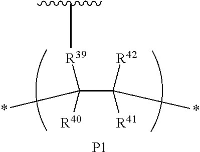 | 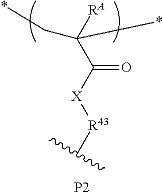 | 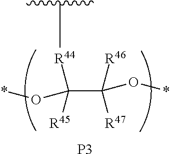 |

With respect to any relevant formula or structural depiction herein, such as M1 or P1, R³⁹ may be -; O; C₁₋₁₂ alkyl, including: linear or branched alkyl having a formula CₐHₐ, or cycloalkyl having a formula CₐH₂ₐ, wherein a is 1, 2, 3, 4, 5, 6, 7, 8, 9, 10, 11, or 12, such as linear or branched alkyl of a formula: CH₂, C₂H₄, C₃H₆, C₄H₈, C₅H₁₀, C₆H₁₂, C₇H₁₄, C₈₁H₁₆, C₉H₁₈, C₁₀H₂₀, etc., or cycloalkyl of a formula: C₃H₄, C₄H₆, C₅H₈, C₆H₁₀, C₇H₁₂, C₈H₁₄, C₉H₁₆, C₁₀H₁₈, etc.; or C₁₋₁₂—O-alkyl-, including: linear or branched —O-alkyl- having a formula —O—CₐHₐ—, or —O-cycloalkyl- having a formula —O—CₐH₂ₐ—, wherein a is 1, 2, 3, 4, 5, 6, 7, 8, 9, 10, 11, or 12, such as linear or branched alkyl of a formula:—O—CH₂—, —O—C₂H₄—, —O—C₃H₆—, —O—C₄H₈—, —O—C₆H₁₀—, —O—C₆H₁₂—, —O—C₇H₁₄—, —O—C₈H₁₆—, —O—C₉H₁₈—, —O—C₁₀H₂₀—, etc., or —O-cycloalkyl- of a formula: —O—C₃H₄—, —O—C₄H₆—, —O—C₆H₈—, —O—C₆H₁₀—, —O—C₇H₁₂—, —O—C₈H₁₄—, —O—C₉H₁₆—, —O—C₁₀H₁₈—, etc., where the —O— may be on either side of the alkyl (e.g. —O-alkyl- or -alkyl-O—).

With respect to any relevant formula or structural depiction herein, such as M1 or P1, R⁴⁰ may be R^{A}, F, Cl, CN, OR^{A}, CF₃, NO₂, NR^{A}R^{B}, COR^{A}, CO₂R^{A}, OCOR^{A}, NR^{A}COR^{B}, or CONR^{A}R^{B}. In some embodiments, R⁴⁰ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc.; F; CI; CN; CF₃; or OCOCH₃.

With respect to any relevant formula or structural depiction herein, such as M1 or P1, R⁴¹ may be R^{A}, F, Cl, CN, OR^{A}, CF₃, NO₂, NR^{A}R^{B}, COR^{A}, CO₂R^{A}, OCOR^{A}, NR^{A}COR^{B}, or CONR^{A}R^{B}. In some embodiments, R⁴¹ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc.; F; CI; CN; CF₃; or OCOCH₃.

With respect to any relevant formula or structural depiction herein, such as M1 or P1, R⁴² may be R^{A}, F, Cl, CN, OR^{A}, CF₃, NO₂, NR^{A}R^{B}, COR^{A}, CO₂R^{A}, OCOR^{A}, NR^{A}COR^{B}, or CONR^{A}R^{B}. In some embodiments, R⁴² may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc.; F; CI; CN; CF₃; or OCOCH₃.

With respect to any relevant formula or structural depiction herein, such as M2 or P2, R⁴³ may be -; C₁₋₁₂ alkyl, including: linear or branched alkyl having a formula CₐHₐ, or cycloalkyl having a formula CₐH₂ₐ, wherein a is 1, 2, 3, 4, 5, 6, 7, 8, 9, 10, 11, or 12, such as linear or branched alkyl of a formula: CH₂, C₂H₄, C₃H₆, C₄H₈, C₅H₁₀, C₆H₁₂, C₇H₁₄, C₈H₁₆, C₉H₁₈, C₁₀H₂₀, etc., or cycloalkyl of a formula: C₃H₄, C₄H₆, C₅H₈, C₆H₁₀, C₇H₁₂, C₈H₁₄, C₉H₁₆, C₁₀H₁₈, etc.; or C₁₋₁₂—O-alkyl-, including: linear or branched —O-alkyl- having a formula —O—CₐHₐ—, or —O— cycloalkyl- having a formula —O—CₐH₂ₐ—, wherein a is 1, 2, 3, 4, 5, 6, 7, 8, 9, 10, 11, or 12, such as linear or branched alkyl of a formula: —O—CH₂—, —O—C₂H₄—, —O—C₃H₆—, —O—C₄H₈—, —O—C₅H₁₀—, —O—C₆H₁₂—, —O—C₇H₁₄—, —O—C₈H₁₆—, —O—C₉H₁₈—, —O—C₁₀H₂O—, etc., or —O-cycloalkyl- of a formula: —O—C₃H₄—, —O—C₄H₆—, —O—C₅H₈—, —O—C₆H₁₀—, —O—C₇H₁₂—, —O—C₈H₁₄—, —O—C₉H₁₆—, —O—C₁₀H₁₈—, etc., where the —O— does not attach to X.

With respect to any relevant formula or structural depiction herein, such as M2 or P2, X may be O or NR^{A}.

With respect to any relevant formula or structural depiction herein, such as M3 or P3, R⁴⁴ may be -; O; C₁₋₁₂ alkyl, including: linear or branched alkyl having a formula CₐHₐ, or cycloalkyl having a formula CₐH₂ₐ, wherein a is 1, 2, 3, 4, 5, 6, 7, 8, 9, 10, 11, or 12, such as linear or branched alkyl of a formula: CH₂, C₂H₄, C₃H₆, C₄H₈, C₅H₁₀, C₆H₁₂, C₇H₁₄, C₈H₁₆, C₉H₁₈, C₁₀H₂₀, etc., or —O-cycloalkyl- of a formula: C₃H₄, C₄H₆, C₅H₈, C₆H₁₀, C₇H₁₂, C₈H₁₄, C₉H₁₆, C₁₀H₁₈, etc.; or C₁₋₁₂—O-alkyl-, including: linear or branched —O-alkyl- having a formula —O—CₐHₐ—, or —O-cycloalkyl- having a formula —O—CₐH₂ₐ—, wherein a is 1, 2, 3, 4, 5, 6, 7, 8, 9, 10, 11, or 12, such as linear or branched alkyl of a formula: —O—CH₂—, —O—C₂H₄—, —O—C₅H₁₀—, —O—C₆H₁₂-, —O—C₂H₁₄-, —O—C₈H₁₆-, —O—C₉H₁₈—, —O—C₁₀H₂₀—, etc., or —O— cycloalkyl- of a formula: —O—C₃H₄—, —O—C₄H₆—, —O—C₆H₈—, —O—C₇H₁₂—, —O—C₈H₁₄—, —O—C₉H₁₆—, —O—C₁₃H₁₈—, etc., where the —O— may be on either side of the alkyl (e.g. —O-alkyl- or -alkyl-O—).

With respect to any relevant formula or structural depiction herein, such as M3 or P3, R⁴⁵ may be R^{A}, F, CI, CN, OR^{A}, CF₃, NO₂, NR^{A}R^{B}, COR^{A}, CO₂R^{A}, OCOR^{A}, NR^{A}COR^{B}, or CONR^{A}R^{B}. In some embodiments, R⁴⁵ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc.; F; CI; CN; CF₃; or OCOCH₃.

With respect to any relevant formula or structural depiction herein, such as M3 or P3, R⁴⁶ may be R^{A}, F, CI, CN, OR^{A}, CF₃, NO₂, NR^{A}R^{B}, COR^{A}, CO₂R^{A}, OCOR^{A}, NR^{A}COR^{B}, or CONR^{A}R^{B}. In some embodiments, R⁴⁶ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc.; F; CI; CN; CF₃; or OCOCH₃.

With respect to any relevant formula or structural depiction herein, such as M3 or P3, R⁴⁷ may be R^{A}, F, CI, CN, OR^{A}, CF₃, NO₂, NR^{A}R^{B}, COR^{A}, CO₂R^{A}, OCOR^{A}, NR^{A}COR^{B}, or CONR^{A}R^{B}. In some embodiments, R⁴⁷ may be H; C₁₋₆ alkyl, such as methyl, ethyl, propyl isomers, cyclopropyl, butyl isomers, cyclobutyl isomers, pentyl isomers, cyclopentyl isomers, hexyl isomers, cyclohexyl isomers, etc.; or C₁₋₆ alkoxy, such as —O-methyl, —O-ethyl, isomers of —O-propyl, —O-cyclopropyl, isomers of —O-butyl, isomers of —O-cyclobutyl, isomers of —O-pentyl, isomers of —O-cyclopentyl, isomers of —O-hexyl, isomers of —O-cyclohexyl, etc.; F; CI; CN; CF₃; or OCOCH₃.

In some embodiments, R²⁴ is M1, M2, M3, P1, P2, or P3. In some embodiments, R²⁴ is M1. In some embodiments, R²⁴ is M2. In some embodiments, R²⁴ is M3. In some embodiments, R²⁴ is P1. In some embodiments, R²⁴ is P2. In some embodiments, R²⁴ is P3.

In some embodiments, R²⁵ is M1, M2, M3, P1, P2, or P3. In some embodiments, R²⁵ is M1. In some embodiments, R²⁵ is M2. In some embodiments, R²⁵ is M3. In some embodiments, R²⁵ is P1. In some embodiments, R²⁵ is P2. In some embodiments, R²⁵ is P3.

In some embodiments, R²⁶ is M1, M2, M3, P1, P2, or P3. In some embodiments, R²⁶ is M1. In some embodiments, R²⁶ is M2. In some embodiments, R²⁶ is M3. In some embodiments, R²⁶ is P1. In some embodiments R²⁶ is P2. In some embodiments, R²⁶ is P3.

In some embodiments, R²⁷ is M1, M2, M3, P1, P2, or P3. In some embodiments, R²⁷ is M1. In some embodiments, R²⁷ is M2. In some embodiments, R²⁷ is M3. In some embodiments, R²⁷ is P1. In some embodiments, R²⁷ is P2. In some embodiments, R²⁷ is P3.

In some embodiments, R²⁸ is M1, M2, M3, P1, P2, or P3. In some embodiments, R²⁸ is M1. In some embodiments, R²⁸ is M2. In some embodiments, R²⁸ is M3. In some embodiments, R²⁸ is P1. In some embodiments, R²⁸ is P2. In some embodiments, R²⁸ is P3.

In some embodiments, R²⁹ is M1, M2, M3, P1, P2, or P3. In some embodiments, R²⁹ is M1. In some embodiments, R²⁹ is M2. In some embodiments, R²⁹ is M3. In some embodiments, R²⁹ is P1. In some embodiments, R²⁹ is P2. In some embodiments, R²⁹ is P3.

In some embodiments, R³⁹ is M1, M2, M3, P1, P2, or P3. In some embodiments, R³⁹ is M1. In some embodiments, R³⁹ is M2. In some embodiments, R³⁹ is M3. In some embodiments, R³⁹ is P1. In some embodiments, R³⁹ is P2. In some embodiments, R³⁹ is P3.

In some embodiments, R³¹ is M1, M2, M3, P1, P2, or P3. In some embodiments, R³¹ is M1. In some embodiments, R³¹ is M2. In some embodiments, R³¹ is M3. In some embodiments, R³¹ is P1. In some embodiments, R³¹ is P2. In some embodiments, R³¹ is P3.

In some embodiments, R³² is M1, M2, M3, P1, P2, or P3. In some embodiments, R³² is M1. In some embodiments, R³² is M2. In some embodiments, R³² is M3. In some embodiments, R³² is P1. In some embodiments, R³² is P2. In some embodiments, R³² is P3.

In some embodiments, R³³ is M1, M2, M3, P1, P2, or P3. In some embodiments, R³³ is M1. In some embodiments, R³³ is M2. In some embodiments, R³³ is M3. In some embodiments, R³³ is P1. In some embodiments, R³³ is P2. In some embodiments, R³³ is P3.

In some embodiments, R³⁴ is M1, M2, M3, P1, P2, or P3. In some embodiments, R³⁴ is M1. In some embodiments, R³⁴ is M2. In some embodiments, R³⁴ is M3. In some embodiments, R³⁴ is P1. In some embodiments, R³⁴ is P2. In some embodiments, R³⁴ is P3.

In some embodiments, R³⁵ is M1, M2, M3, P1, P2, or P3. In some embodiments, R³⁵ is M1. In some embodiments, R³⁵ is M2. In some embodiments R³⁵ is M3. In some embodiments, R³⁵ is P1. In some embodiments, R³⁵ is P2. In some embodiments, R³⁵ is P3.

In some embodiments, R³⁶ is M1, M2, M3, P1, P2, or P3. In some embodiments, R³⁶ is M1. In some embodiments, R³⁶ is M2. In some embodiments, R³⁶ is M3. In some embodiments, R³⁶ is P1. In some embodiments, R³⁶ is P2. In some embodiments, R³⁶ is P3.

In some embodiments, R³⁷ is M1, M2, M3, P1, P2, or P3. In some embodiments, R³⁷ is M1. In some embodiments, R³⁷ is M2. In some embodiments, R³⁷ is M3. In some embodiments, R³⁷ is P1. In some embodiments, R³⁷ is P2. In some embodiments, R³⁷ is P3.

In some embodiments, R³⁸ is M1, M2, M3, P1, P2, or P3. In some embodiments, R³⁸ is M1. In some embodiments, R³⁸ is M2. In some embodiments, R³⁸ is M3. In some embodiments, R³⁸ is P1. In some embodiments, R³⁸ is P2. In some embodiments, R³⁸ is P3.

With respect to Formula 1, in some embodiments, R²⁴, R²⁶, R²⁷, R²⁹, R³⁰, R³¹, R³², and R³³ are H, and the remaining groups are as shown in Table 3.

TABLE 3

| Compound | R²⁵ | R²⁸ | R³⁴ | R³⁵ | R³⁶ | R³⁷ | R³⁸ |
|---|---|---|---|---|---|---|---|
| A | H | H | H | H | H | H | H |
| B | H | H | H | H | H | H | CH₃ |
| C | H | H | CH₂CH₃ | H | CH₂CH₃ | H | CH₂CH₃ |
| D | CH₃ | CH₃ | CH₂CH₃ | H | CH₂CH₃ | H | CH₂CH₃ |
| E | H | H | CH₃ | H | CH₃ | H | H |
| F | H | H | CH₂CH₃ | CH₂CH₃ | CH₂CH₃ | CH₂CH₃ | H |
| G | H | H | CH₂CH₃ | CH₂CH₃ | CH₂CH₃ | CH₂CH₃ | CH₂CH₃ |
| H | CH₃ | CH₃ | CH₂CH₃ | H | CH₂CH₃ | H | H |
| I | H | H | CH₃ | CH₃ | CH₃ | CH₃ | H |
| J | H | H | CH₃ | CH₃ | CH₂CH₃ | CH₂CH₃ | H |

With respect to Formula 1, in some embodiments R²⁴, R²⁶, R²⁷, and R²⁹; one of R³⁰, R³¹, R³², and R³³ is R² or a polymerized group of Wand the remaining three groups of R³⁰, R³¹, R³², and R³³ are H; and the remaining groups of Formula, are as shown in Table 4.

TABLE 4

| Compound | R^{Z} | R²⁵ | R²⁸ | R³⁴ | R³⁵ | R³⁶ | R³⁷ | R³⁸ |
|---|---|---|---|---|---|---|---|---|
| K | methacrylate | H | H | CH₂CH₃ | CH₂CH₃ | CH₂CH₃ | CH₂CH₃ | H |
| L | propyl-3- | H | H | CH₂CH₃ | CH₂CH₃ | CH₂CH₃ | CH₂CH₃ | H |
| | methacrylate: | | | | | | | |
| M | propyl-3- | H | H | CH₃ | CH₃ | CH₂CH₃ | CH₂CH₃ | H |
| | methacrylate: | | | | | | | |
| N | methacrylate | H | H | H | H | H | H | CH₃ |
| O | propyl-3- | H | H | CH₂CH₃ | H | CH₂CH₃ | H | CH₂CH₃ |
| | methacrylate: | | | | | | | |

In some embodiments, a luminescent compound may be rhodamine B.

Light Absorbing Dye

In some embodiments, the composition can comprise a light absorbing dye. In some embodiments, the light absorbing dye can have a full width half maximum (FWHM) of visible absorption of up to and including 100 nm. In some embodiments, the light absorbing dye can have a full width half maximum of about 10-40 nm, about 10-30 nm, or about 20 nm. The FWHM is the width of an absorption or emission band in nanometers at the absorption or emission intensity that is half of the maximum absorption or intensity value for the band. In an embodiment, the light absorbing dye has an absorption band with a FWHM value that is less than or equal to about 100 nm, less than or equal to about 75 nm, or less than or equal to about 50 nm, less than or equal to about 25 nm when dispersed in said substantially transparent matrix, for example about 20 nm.

In some embodiments, the light absorbing dye can have an absorption wavelength range that overlaps with the luminescent compound's emission's wavelength range. The absorbance band of a light absorbing dye may overlap with the emission band of the luminescent compound in this case, resulting in less than 100% transmittance in one or more of the wavelengths associated with the color green, yellow, orange, or red.

The absorption peak of the light absorbing dye can vary. For example, the absorption band peak of the light absorbing dye may be in the range of about 445-525 nm, about 445-505 nm, about 520-580 nm, or about 575-625 nm, about 595 nm, about 500-540 nm, about 540-580 nm, about 580-620 nm, about 620-660 nm, about 580-610 nm, about 500-570 nm, or about 570-630 nm. In some embodiments, the light absorbing dye can have an absorbance maximum of about 585-605 nm. In some embodiments, the light absorbing dye can have an absorbance maximum of 595 nm.

When a light absorbing dye has an absorption wavelength range that overlaps with a luminescent compound's emission wavelength range, the light absorbing dye can practically reduce or completely reduce the fluorescence of a luminescent compound. In some embodiments, the light absorbing dye can reduce the fluorescent emissions of the luminescent compound by about 50% to about 99.9%.

A light-absorbing dye may or may not be fluorescent. In some embodiments, the light absorbing dye can have a fluorescent yield of less than 1%. For example, the light absorbing dye will emit less than 1% of the total photons that the dye absorbs, virtually making the dye non-fluorescent. In some embodiments, the light absorbing dye may have fluorescence quantum yield above 1%, but the fluorescence emission can be in non-visible wavelengths. For example, the light absorbing dye may have an absorbance in the range of 560 nm to 610 nm, and a fluorescent emission in the range of 750 nm to 850 nm.

A light-absorbing dye may absorb one color, such as red, and may be transparent to all other wavelengths of light. In some embodiments, a purpose of the light-absorbing dye is to make objects of the same color as the dye's absorption band appear darker when viewed through the filter. More than one light absorbing dye can be used. However, the substantial transparency of the optical element should be maintained. In some embodiments, the light absorbing dye's absorbance maximum can be about 595 nm. In some embodiments, the light absorbing dye can have a full width half mass (FWHM) of about 10-40 nm, about 10-30 nm, or about 20 nm. In some embodiments, the light absorbing dye can comprise a porphyrin or a porphyrin derivative. In some embodiments, the porphyrin or porphyrin derivative can have the general formula:

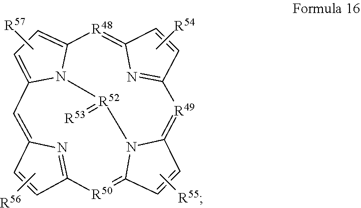

wherein R⁴⁸, R⁴⁹, R⁵⁰ and R⁵¹ can be C—H, C—R^{A}, or N; R⁵² may be C or a group five (5) transitional metal; R⁵³ may be: O, NR^{A}, or S; and R⁵⁴, R⁵⁵, R⁵⁶, and R⁵⁷ may be an unsubstituted C₁-C₄ alkyl.

In some embodiments, R⁴⁸, R⁴⁹, R⁵⁰ and R⁵¹ may be N.

In some embodiments, R⁵² may be V or C.

In some embodiments, R⁵³ may be 0.

In some embodiments, R⁵⁴, R⁵⁵, R⁵⁶, and R⁵⁷ may be a C₄-alkyl such as n-butyl, isobutyl:

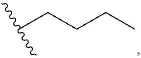 [SMILES: *CCCC]

and/or

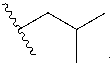 [SMILES: *CC(C)C]

In some embodiments, the light absorbing dye is a porphyrin:

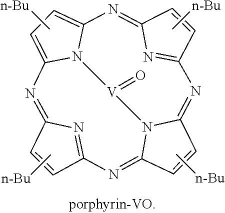

In some embodiments, the light absorbing dye can down shift (red shift) a selected peak wavelength to increase the distinctiveness between the first and the second colors. For example, the light absorbing dye can have an absorption peak wavelength substantially the same as the emissive peak wavelength at about the peak of the red sensitivity wavelength or along the slope of the sensitivity, e.g., about 550-660 nm, such as about 550-560 nm, about 560-570 nm, about 570-580 nm, about 580-590 nm, about 590-600 nm, about 600-610 nm, about 610-620 nm, about 620-630 nm, about 630-640 nm, about 640-650 nm, about 650-660 nm, about 550-580 nm, about 580-610 nm, about 610-640 nm, about 640-660 nm, about 550-600 nm, or about 600-660 nm.

Any suitable ratio of luminescent compound to light absorbing dye may be used, such as about 0.1-100 (10 g of luminescent compound and 1 g of light absorbing dye is a ratio of 10), such as about 0.1-0.5, about 0.5-1, about 1-2, about 2-3, about 3-4, about 4-5, about 5-6, about 6-7, about 0.1-3, about 3-6, about 6-9, about 0.1-2, about 2-4, about 4-6, about 6-8, or about 1-7.

In some embodiments, the composition can produce a haze. Haze, in a compound, is created due to the fluorescent emissions of the luminescent compound. Luminescent compound absorbs light energy of a specific wavelength, in the form of photons, and emits the light energy, or photons at a longer wavelength. These emitted photons are not in a linear path, but rather they are emitted in all directions. In certain instances, this scattered release of emitted photons can create a haze in the visual spectrum. It is believed that the use of the light absorbing dye, which has an absorption wavelength that substantially overlaps with the emission wavelength of the luminescent compound, prevents a large scattering of light energy or photons. This reduction in the emission of light energy or photons greatly reduces or eliminates hazing caused by the emission of the light energy. In some embodiments, the composition can produce a haze that is less than 0.3%.

In some embodiments, the composition can further comprise a substantially transparent matrix. The substantially transparent matrix can comprise a composition that includes glass or various types of polymers in various combinations with a luminescent compound, a light absorbing dye and or combinations thereof. It may be desirable for the material to be non-harmful and robust. It may be desirable to select the transparent matrix material to have a high refractive index. In some embodiments, the transparent matrix can have a refractive index from about 1.3 to about 1.5. In some embodiments, the transparent matrix can have a refractive index from about 1.45 to about 1.7. In some embodiments, the transparent matrix can have a refractive index from about 1.6 to about 1.8. In some embodiments, the transparent matrix can have a refractive index of about 1.65 to about 2.1. In some embodiments, the transparent matrix can have a refractive index higher than about 1.5. In some embodiments, the transparent matrix can have a refractive index higher than about 1.9. In some embodiments, the transparent matrix can have a refractive index higher than about 2.0. In some embodiments, the refractive index of the transparent matrix can be selected to be high to trap stray fluorescent photons and guide them away from the user's eye. In some embodiments, the substantially transparent matrix can comprise a material, including, but not limited to, glass; a thiourethane; a polycarbonate (PC); allyl diglycol carbonate (such as CR-39); a polyacrylate, such as polyacrylic acid, polyalkacrylic acid (including methacrylic acid), an ester of a polyacrylic acid or a polyacrylic acid such as a methyl ester, an ethyl ester, an propyl ester, an isopyolyl ester, an n-butyl ester, a sec-butyl ester, an isobutyl ester, a t-butyl ester, an ester of a pentyl isomer, an ester of a hexyl isomer, a cyclobutyl ester, a cyclopentyl ester, or a cyclohexyl ester, etc., 2-hydroxyethylmethacrylate, and including polyacrylate hydrogels; polyvinylpyrrolidinone; one or more terpolymers of hexafluoroacetone-tetrafluoroethylene-ethylene (HFA/TFE/E terpolymers) polymethyl methacrylate (PMMA), a polyvinyl butyral (PVB), ethylene vinyl acetate, ethylene tetrafluoroethylene, a polyimide a polystryrene, a polyurethane, organosiloxane, a poly(vinyl butyl-co-vinyl alcohol-co-vinyl) acetate, and combinations thereof.

Some embodiments include an optical element composition comprising the composition described herein.

Some embodiments include an optical element for correcting visual insensitivity between a first visible color wavelength and a second visible color wavelength. In some embodiments, the optical element can comprise a substantially transparent matrix material. In another embodiment, the optical element can comprise a luminescent compound. In still another embodiment, the optical element can comprise a light absorbing dye. In some embodiments, the luminescent compound and the light absorbing dye are dispersed within the substantially transparent matrix material. In an embodiment, the luminescent compound has an emissive wavelength that substantially overlaps with the first visible color wavelength. In some embodiments, the light absorbing dye can have an absorbance wavelength that substantially overlaps with the first visible light color wavelength that could otherwise pass through the optical element.

An optical element can be manufactured in accordance with known film-forming or lens-forming techniques. The luminescent compound and light absorbing dye can be combined with the substantially transparent matrix material in an appropriate weight ratio. The luminescent compound and light absorbing dye can be mixed with a thermoplastic, melted to allow homogeneous mixing, and then molded into the shape of a glasses lens or blank to provide a corrective optical element. Alternatively, the ingredients can be dissolved in an appropriate solvent, such as toluene, optionally with the use of sonication. The solution can then be spin-coated into a film or onto any substantially transparent substrate. Heating the resulting film to evaporate the solvent provides a corrective optical element, which can be placed between a color blind person's eyes and an object that they are viewing to be effective. The luminescent compound and light absorbing dye can be dissolved in an appropriate swelling solvent, such as water at any temperature, or any organic solvent, and the transparent matrix (i.e. blank lens material) can be dipped into the swelling solvent containing the dye, so that the dye molecules penetrate the transparent matrix with the swelling solvent. Then, the transparent matrix can be removed from the solvent bath and dried, removing the solvent but leaving behind the colorant molecules in the transparent matrix, providing the corrective optical element.

The optical element described herein is not limited in its form. Preferably, the optical element can be designed such that it can be placed in a known manner between a user's eye and any object or image to be perceived. In an embodiment, the optical element comprises a film. The film can have varying thickness. In an embodiment, the film is attached to a piece of eyewear. For example, the optical element can comprise a lens. The luminescent compound can be dispersed within the lens material, or it can be dispersed in a film that is attached to the lens material. In an embodiment, the lens comprises a contact lens or an eyeglass lens. A substantially transparent matrix may be composed of any suitable material. In some embodiments, the optical element containing luminescent and light absorbing compounds can be a film that is attached to an electronic display, such as a computer monitor, television display, or hand-held electronic device with a display such as a phone.

Some optical elements may comprise a substantially transparent matrix of polymer and a rhodamine or a rhodamine derivative as a luminescent compound, such as rhodamine B, and a light absorbing dye, such as porphyrin or porphyrin derivatives, wherein the polymer comprises polyvinyl butyral. In some embodiments a luminescent compound may have a high quantum yield, along with a maximum emission wavelength at the first visible color wavelength. For example, where the first visible color wavelength is green, a luminescent compound with a maximum absorption in the green wavelength may be used. In some embodiments, the luminescent compound has a peak emission at a wavelength in the range of about 450 nm to about 650 nm, about 500 nm to about 625 nm, or about 540 nm to about 600 nm. Upon excitation by visual light, the luminescent compound enhances the emissive intensity within the second color wavelength range. In some embodiments, the luminescent compound has a quantum yield that is greater than about 75%, about 80%, about 85%, or about 90%.

In some embodiments, the optical element can comprise a device for improving color discernment in a mammal in need thereof.

The optical elements described herein are useful in methods for correcting visual insensitivity in a mammal. In an embodiment, the method comprises identifying an individual having a visual insensitivity between a first visible color wavelength and a second visible color wavelength. In an embodiment, the method comprises selecting an optical element as described herein that corrects the visual insensitivity. In an embodiment, the method comprises providing or arranging to provide the optical element to the individual. In an embodiment, the visual insensitivity comprises deuteranomaly.

### EMBODIMENTS

Embodiment 1 A composition comprising:

a luminescent compound; and

a light absorbing dye;

wherein the luminescent compound absorbs light in a wavelength range near peak sensitivity for an M human cone photopigment and emits light of a longer wavelength in a wavelength range near peak sensitivity for a L human cone photopigment;

wherein the luminescent compound has a median wavelength of visible absorption, an average wavelength of visible absorption, or a peak wavelength of visible absorption of about 530 nm to about 580 nm; and

wherein the light absorbing dye has a full width half maximum of 20 nm.

Embodiment 2 The composition of embodiment 1, wherein the luminescent compound has a fluorescent emission that substantially overlaps a human L cone emission wavelength range.

Embodiment 3 The composition of embodiments 1 and 2, wherein the light absorbing dye has an absorption wavelength range that overlaps with the luminescent compound's emission wavelength range.

Embodiment 4 The composition of embodiments 1-3, wherein the light absorbing dye has an absorbance maximum of about 585 nm to about 605 nm.

Embodiment 5 The composition of embodiment 1-5, wherein the light absorbing dye reduces the fluorescent emissions of the luminescent compound by about 50% to about 99.9%.

Embodiment 6 The composition of embodiment 1-6, wherein the light absorbing dye has a fluorescent yield of less than 1%.

Embodiment 7 The composition of embodiments 1-9, wherein the luminescent compound comprises a rhodamine derivative dye.

Embodiment 8 The composition of any one of embodiments 1-8, wherein the luminescent compound is:

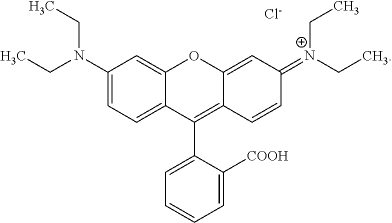 [SMILES: CCN(CC)c1ccc2c(-c3ccccc3C(=O)O)c3ccc(=[N+](CC)CC)cc-3oc2c1 ; [Cl-]]

Embodiment 9 The composition of embodiments 1-9, wherein the light absorbing dye comprises a porphyrin derivative, Embodiment 10 The composition of any one of embodiments 1-8, wherein the light absorbing dye is a porphyrin of formula:

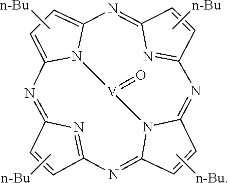

Embodiment 11 The composition of embodiment 1-10, further comprising a substantially transparent matrix.

Embodiment 12 The composition of embodiment 11, wherein substantially transparent matrix comprises any material suitable for an optical lens or contact lens.

Embodiment 13 The composition of embodiments 1-12, wherein the composition comprises an optical element.

Embodiment 14 The composition of embodiment 13, wherein the optical element produces a haze that is less than 0.3%.

Embodiment 15 An optical element for correcting visual insensitivity between a first visible color wavelength and a second visible color wavelength, comprising:
a substantially transparent matrix material;
a luminescent compound; and
a light absorbing dye;
wherein the luminescent compound and the light absorbing dye are dispersed within the substantially transparent matrix material,
wherein the luminescent compound has an emissive wavelength that substantially overlaps with the first visible color wavelength and the light absorbing dye has an absorbance wavelength that substantially overlaps with the first visible color wavelength and absorbs about 1% to about 99.9% of the first visible light color wavelength that would otherwise pass through the optical element.

Embodiment 16 The optical element of embodiment 16, wherein the luminescent compound comprises a rhodamine derivative dye.

Embodiment 17 The optical element of embodiment 17, wherein the rhodamine derivative dye is:

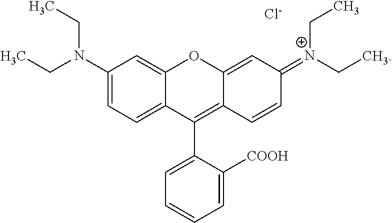 [SMILES: CCN(CC)c1ccc2c(-c3ccccc3C(=O)O)c3ccc(=[N+](CC)CC)cc-3oc2c1 ; [Cl-]]

Embodiment 18 The optical element of embodiment 16, wherein the light absorbing dye is a porphyrin derivative.

Embodiment 19 The optical element of embodiment 19, wherein the porphyrin derivative is:

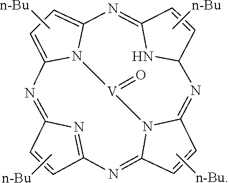

Embodiment 20 The optical element of embodiment 15, wherein the optical element comprises a device for improving color discernment in a mammal in need thereof.

### EXAMPLES

### Example 1.0 Stock Polymeric Solution

The comparative solution (CS-1) was synthesized as follows; (2.5 g) of poly(vinyl butyral) (PVB) was added to a mixture of n-butanol (40 mL) and N-methyl pyrrolidone (NMP) (10 mL) in a 250 mL Erlenmeyer flask. The mixture was warmed to 60° C. and stirred until a clear homogeneous polymer solution was obtained. Next, the clear homogeneous polymer solution was allowed to cool to room temperature.

### Example 1.1 Solution 1

To a 20 mL glass vial add 10 mL of CS-1 and stir. Next, 20 mg of rhodamine B was added and stirred until the rhodamine B was completely dissolved and a homogeneous solution was obtained. (S-1)

### Example 1.2 Solution 2

To a 20 mL glass vial add 10 mL of CS-1 and stir. Next, 20 mg of rhodamine B and 3 mg of porphyrin-VO dye was added and stirred until the rhodamine B was completely dissolved and a homogeneous solution was obtained. (S-2)

### Example 1.3 I Solution 3

To a 20 mL glass vial add 10 mL of CS-1 and stir. Next, 20 mg of rhodamine B and 5 mg of porphyrin-VO dye was added and stirred until the rhodamine B was completely dissolved and a homogeneous solution was obtained. (S-3)

### Example 1.4 Solution 4

To a 20 mL glass vial add 10 mL of CS-1 and stir. Next, 20 mg of rhodamine B and 10 mg of porphyrin-VO dye was added and stirred until the rhodamine B was completely dissolved and a homogeneous solution was obtained. (S-4)

### Example 2 Coating Preparation

Six glass slides were cleaned with soap and water and subsequently rinsed with methanol and acetone. The washed slides were next, dried under flowing nitrogen gas. Once dried the glass slides were placed in a clean dust free container.

### Example 2.1: PVB Reference Solution

A pre-cleaned (method aforementioned) glass slide was spin coated with 1 mL of CS-1. The spin coater program was as followed, a 10 sec ramp up to 1,200 rpm, a 10 sec hold at 1,200 rpm, followed by a 3.5 sec deceleration to 0 rpm. The glass slide coated with CS-1 was placed in a 90° C. oven for 2 minutes to obtain a substantially dry polymer film coated glass slide. (EX-1)

### Example 2.2: Rhodamine in PVB

A pre-cleaned (method aforementioned) glass slide was spin coated with 1 mL of S-1. The spin coater program was as followed, a 10 sec ramp up to 1,200 rpm, a 10 sec hold at 1,200 rpm, followed by a 3.5 sec deceleration to 0 rpm. The glass slide coated with S-1 was placed in a 90° C. oven for 2 minutes to obtain a substantially dry polymer film coated glass slide. (EX-2)

### Example 2.3: 20:3 Ratio Rhodamine and Porphyrin in PVB

A pre-cleaned (method aforementioned) glass slide was spin coated with 1 mL of S-2. The spin coater program was as followed, a 10 sec ramp up to 1,200 rpm, a 10 sec hold at 1,200 rpm, followed by a 3.5 sec deceleration to 0 rpm. The glass slide coated with S-2 was placed in a 90° C. oven for 2 minutes to obtain a substantially dry polymer film coated glass slide. (EX-3)

### Example 2.4: 4:1 Ratio of Rhodamine and Porphyrin in PVB

A pre-cleaned (method aforementioned) glass slide was spin coated with 1 mL of S-3. The spin coater program was as followed, a 10 sec ramp up to 1,200 rpm, a 10 sec hold at 1,200 rpm, followed by a 3.5 sec deceleration to 0 rpm. The glass slide coated with S-3 was placed in a 90° C. oven for 2 minutes to obtain a substantially dry polymer film coated glass slide. (EX-4)

### Example 2.5: 2:1 Ratio of Rhodamine and Porphyrin in PVB

A pre-cleaned (method aforementioned) glass slide was spin coated with 1 mL of S-4. The spin coater program was as followed, a 10 sec ramp up to 1,200 rpm, a 10 sec hold at 1,200 rpm, followed by a 3.5 sec deceleration to 0 rpm. The glass slide coated with S-4 was placed in a 90° C. oven for 2 minutes to obtain a substantially dry polymer film coated glass slide. (EX-5)

### Example 3: Percent Light Transmittance Measurement

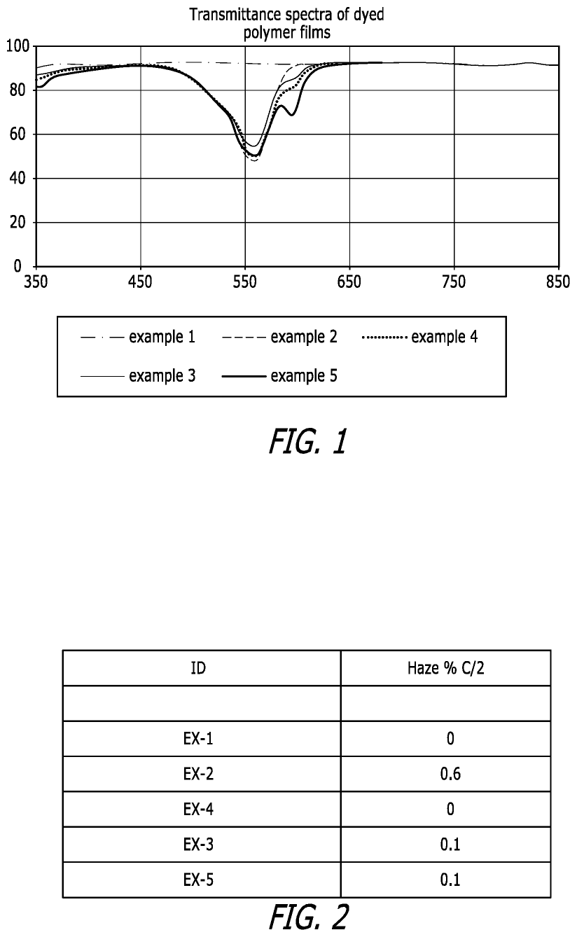

The percentage of light transmittance (% T) for PVB alone (EX-1), Rhodamine B in PVB (EX-2), 20:3 Rhodamine B: Porphyrin in PVB (EX-3), 4:1 Rhodamine B: Porphyrin in PVB (EX-4) and 2:1 Rhodamine B: Porphyrin in PVB (EX-5), were measured using HunterLab UltraScan Pro (Hunter Associates Laboratory, Inc. Reston, Va., USA). FIG. 1 shows the results, wherein the x-axis is the wavelength of light in nanometers (nm) and the y-axis is % T. EX-1 (PVB alone) shows a consistant % T with no absorbance bands. EX-2 (Rhodamine Bin PVB) shows an absorb and peak of light at about 560 nm, EX-3 (20:3 ratio Rhodamine B: Porphyrin in PVB) shows one absorbance peak of light at about 560 nm and a second absorbance band starting to form at about 585 nm to about 605 nm, EX-4 (4:1 ratio Rhodamine B: Porphyrin in PVB) shows one absorbance peak of light at about 560 nm and a second more pronounced absorbance band starting to form at about 585 nm to about 605 nm, and EX-5 (2:1 ratio Rhodamine B: Porphyrin in PVB) shows one absorbance peak of light at about 560 nm and a second distinct absorbance peak at about 595 nm. The results indicate that increasing levels of the light absorbing Porphyrin dye generates the second absorbance peak at around 595 nm.

### Experiment 4: Haze Measurements

The percentage of light transmittance (% T) for PVB alone (EX-1), Rhodamine B in PVB (EX-2), 20:3 Rhodamine B: Porphyrin in PVB (EX-3), 4:1 Rhodamine B: Porphyrin in PVB (EX-4) and 2:1 Rhodamine B: Porphyrin in PVB (EX-5), were measured using HunterLab UltraScan Pro (Hunter Associates Laboratory, Inc. Reston, Va., USA) using the C/2 illuminant/observer setting. FIG. 2 shows the results, note that EX-1 the PVB alone had no haze whereas EX-2 the Rhodamine alone has the highest % haze value (0.6%), EX-3 20:3 and EX-5 2:1 ratio Rhodamine: Porphyrin combination, in PVB, produced slight haze (0.1%) and EX-4 4:1 ratio of Rhodamine: Porphyrin combination, in PVB, produce no haze (0%).

The terms “a,” “an,” “the” and similar referents used in the context of describing the invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of any claim. No language in the specification should be construed as indicating any non-claimed element essential to the practice of the invention.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience. When any such inclusion or deletion occurs, the specification is deemed to contain the group as modified thus fulfilling the written description of all Markush groups used in the appended claims.

Certain embodiments are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

What is claimed is:

1. A composition comprising:
a luminescent compound; and
a light absorbing dye;
wherein the luminescent compound has a median wavelength of visible absorption, an average wavelength of visible absorption, or a peak wavelength of visible absorption in a range about 530 nm to about 580 nm;
wherein the addition of the light absorbing dye has full width at half max in a range of about 10 nm to about 40 nm, and addition of the light absorbing dye to the composition results in a second absorption peak at a wavelength above about 580 nm;
wherein the composition has a transmittance of at least 10% at 450 nm and a transmittance of at least 10% at 650 nm.

2. The composition of claim 1, wherein the weight ratio of the luminescent compound to the light absorbing dye is about 1 to about 7.

3. The composition of claim 1, wherein the light absorbing dye has an absorption wavelength range that overlaps with an emission wavelength range of the luminescent compound.

4. The composition of claim 1, wherein the light absorbing dye has an absorbance maximum of about 585 nm to about 605 nm.

5. The composition of claim 1, wherein the light absorbing dye absorbs about 50% to about 99.9% of the fluorescent emission of the luminescent compound.

6. The composition of claim 1, wherein the light absorbing dye has a fluorescent yield of less than 1%.

7. The composition of claim 1, wherein the luminescent compound comprises a rhodamine derivative dye.

8. The composition of claim 1, wherein the luminescent compound is rhodamine B:

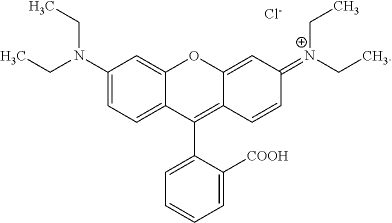 [SMILES: CCN(CC)c1ccc2c(-c3ccccc3C(=O)O)c3ccc(=[N+](CC)CC)cc-3oc2c1 ; [Cl-]]

9. The composition of claim 1, wherein the light absorbing dye comprises a porphyrin derivative.

10. The composition of claim 1, wherein the light absorbing dye is:

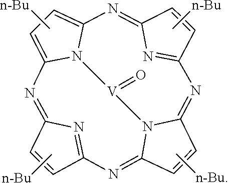

11. The composition of claim 1, further comprising a substantially transparent matrix, wherein the luminescent compound and the light absorbing dye are dispersed within the substantially transparent matrix.

12. The composition of claim 11, wherein substantially transparent matrix comprises any material suitable for an optical lens or contact lens.

13. The composition of claim 1, wherein the composition is part of an optical element.

14. The composition of claim 13, wherein the optical element produces a haze that is less than 0.3%.

15. An optical element for correcting visual insensitivity between a first visible color wavelength and a second visible color wavelength, comprising:
a substantially transparent matrix material;
a luminescent compound; and
a light absorbing dye;
wherein the luminescent compound and the light absorbing dye are dispersed within the substantially transparent matrix material, wherein the luminescent compound has an emissive wavelength that overlaps with the first visible color wavelength and the light absorbing dye has an absorbance wavelength that overlaps with the first visible color wavelength and absorbs about 1% to about 99.9% of the first visible light color wavelength that would otherwise pass through the optical element.

16. The optical element of claim 15, wherein the luminescent compound comprises a rhodamine derivative dye.

17. The optical element of claim 16, wherein the rhodamine derivative dye is rhodamine B:

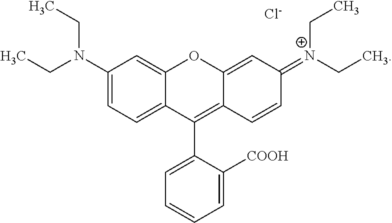 [SMILES: CCN(CC)c1ccc2c(-c3ccccc3C(=O)O)c3ccc(=[N+](CC)CC)cc-3oc2c1 ; [Cl-]]

18. The optical element of claim 15, wherein the light absorbing dye is a porphyrin derivative.

19. The optical element of claim 18, wherein the porphyrin derivative is:

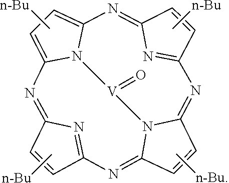

20. The optical element of claim 15, wherein the optical element is part of a device for improving color discernment in a mammal in need thereof.
